(19) United States
(12) Patent Application Publication
(10) Pub. No.: US 2025/0147887 A1
(43) Pub. Date: May 8, 2025

(54) MULTI-TIERED CACHE SYSTEM

(71) Applicant: PAYPAL, INC., San Jose, CA (US)

(72) Inventors: Sharmili Srinivasan, Tamil Nadu (IN); Pranav Ashok Dhakras, Pune (IN); Soujanya Lanka, Singapore (SG); Guangsen Wang, Singapore (SG); Reyha Verma, Bangalore Urban (IN)

(21) Appl. No.: 19/012,401

(22) Filed: Jan. 7, 2025

Related U.S. Application Data
(63) Continuation-in-part of application No. 18/759,399, filed on Jun. 28, 2024.

(30) Foreign Application Priority Data
Aug. 14, 2023 (IN) 202341054463
Nov. 8, 2023 (IN) 202341076442
Nov. 27, 2024 (IN) 202441092693

(51) Int. Cl. G06F 12/0811

(52) U.S. Cl. CPC G06F 12/0811

(57) ABSTRACT

Methods and systems are presented for providing multi-tiered cache system that works with an artificial intelligence (AI)-based conversation system for facilitating a conversation with users and processing transactions for the users. The multi-tiered cache system includes multiple tiers of cache modules that use different structures for caching and/or querying data. As a new utterance is received, the cache system uses each of the cache modules in sequence to determine whether a cache hit occurs. If a cache miss occurs at a first cache module, the cache system determines if a cache hit occurs at a second cache module. When a response is obtained from one of the cache modules and/or the AI model, the cache system updates the cache modules using the response.

### CROSS-REFERENCE TO RELATED APPLICATIONS

This application claims priority to Indian Provisional Patent Application No. 202441092693, filed on Nov. 27, 2024, and is also a continuation-in-part of U.S. patent application Ser. No. 18/759,399, filed on Jun. 28, 2024, which claims priority under 35 U.S.C. § 119 to Indian Provisional Patent Application No. 202341054463, filed on Aug. 14, 2023, and to Indian Provisional Patent Application No. 202341076442, filed on Nov. 8, 2023, which are incorporated by reference herein in their entirety.

### BACKGROUND

The present specification generally relates to computer-based automated interactive services, and more specifically, to a framework for providing a conversational artificial intelligence system configurable to interact with users and to perform various transactions for the users according to various embodiments of the disclosure.

### RELATED ART

Service providers typically provide a platform for interacting with their users. The platform can be implemented as a website, a mobile application, or a phone service, through which the users may access data and/or services offered by the service provider. While these platforms can be interactive in nature (e.g., the content of the platform can be changed based on different user interactions, etc.), they are fixed and bound by their structures. In other words, users have to navigate through the platform to obtain the desired data and/or services. When the data and/or the service desired by a user is “hidden” (e.g., requiring multiple navigation steps that are not intuitive, etc.), it may be difficult for the user to access the data and/or the service purely based on manual navigation of the platform.

In the past, service providers have often dedicated one or more information pages, such as a “Frequently Asked Questions (FAQ)” page, within the platforms for assisting users to access data and/or services that are popular in demand. The information pages may include predefined questions, such as “how to change my password” and pre-populated answers to the questions. However, given that the questions were pre-generated, a user who is looking for data and/or services is still required to navigate through the information pages to find a question that matches the data and/or services that the user desires. If the desired data and/or services do not match any of the questions on the information pages, the user will have to manually navigate the platform or contact a human agent of the service provider. Furthermore, the information pages also create an additional burden for the service provider, as the answers to the pre-generated questions would need to be reviewed and/or modified as necessary whenever any one of the platform, the data, and/or the services offered by the service provider is updated. Thus, there is a need for an advanced framework for providing data and/or services to users in a natural and intuitive way.

### BRIEF DESCRIPTION OF THE FIGURES

FIG. 1 is a block diagram illustrating an electronic transaction system according to an embodiment of the present disclosure;

FIG. 2 is a block diagram illustrating a conversation module according to an embodiment of the present disclosure;

FIG. 3 illustrates an example data flow for processing utterances according to an embodiment of the present disclosure;

FIG. 4 illustrates an example data flow for using an artificial intelligence model to process transactions according to an embodiment of the present disclosure;

FIG. 5 is a block diagram of an evaluation module according to an embodiment of the present disclosure;

FIG. 6A is a block diagram of a knowledge module according to an embodiment of the present disclosure;

FIG. 6B illustrates a data flow for querying a first-tier cache module according to an embodiment of the present disclosure;

FIG. 6C illustrates a data flow for querying a second-tier cache module according to an embodiment of the present disclosure;

FIG. 7 is a flowchart showing a process of facilitating a conversation between an artificial intelligence model and a user according to an embodiment of the present disclosure;

FIG. 8 is a flowchart showing a process of using an artificial intelligence model to instruct various software modules to process different types of transactions according to an embodiment of the present disclosure;

FIG. 9 is a flowchart showing a process of evaluating the quality of a conversation system according to an embodiment of the present disclosure;

FIG. 10 is a flowchart showing a process of using a cache system to determine content for an utterance according to an embodiment of the present disclosure;

FIG. 11 illustrates an example neural network that can be used to implement a machine learning model according to an embodiment of the present disclosure; and

FIG. 12 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for providing a computer framework that uses one or more artificial intelligence (AI) models to interact with, and provide services to, users. As used herein, an AI model is a computer-based model that can be configured and trained to provide natural conversation services for users (e.g., automatically interpreting input utterances submitted by the users, and to generate output utterances to the users in a natural language format, such as free-form/unstructured texts, to facilitate natural dialogues with the users, etc.). Example AI models may include machine learning models, deep learning neural networks, large language models, small language models, etc.

Conventional dialogue systems (also known as “chat robots” or “chat bots”) that are not AI-based are typically inflexible, as they are configured to provide mostly pre-generated answers. On the other hand, an AI-based conversation system is flexible and can be configured to provide natural and unstructured dialogues with users (e.g., by providing utterances to users that are dynamically generated in real-time, such as generated within several seconds from receiving an utterance from the users, etc.). An utterance may include one or more sentences and/or phrases in a natural language format. For example, in some embodiments, the AI-based conversation system can be trained using training data including web content, videos, audio, white papers, articles, books, or other materials that are related to an organization, such that the AI-based conversation system may dynamically generate answers to a user query by providing relevant information associated with the organization to the users via natural dialogues. In addition, the AI-based conversation system may also be trained using training data that includes programming code and application programming interface (API) calls with various parameters and input values, such that the AI-based conversation system may dynamically communicate with, and provide instructions (e.g., API calls, etc.) to, different backend computer programs (e.g., transaction processing modules, etc.) to perform various types of transactions for the users.

As such, according to various embodiments of the disclosure, the computer framework may provide one or more AI models to the AI-based conversation system, where the one or more AI models may be communicatively coupled with a chat interface and various backend modules, for providing conversation and transaction services to users. The chat interface may be part of a chat system that facilitates chat-based communications between users of the organization and the AI-based conversation system. For example, the chat system may include chat clients that can be installed and executed on various user devices of the users of the organization. Each chat client may also provide a chat interface for a user on a user device. Through the chat interface provided by the chat client, a user may initiate a chat session with the AI-based conversation system and may conduct a conversation with the AI-based conversation system (e.g., one or more dialogues between the user and the AI-based conversation system). For example, a user may, via a chat client and during a chat session with the AI-based conversation system, ask for information related to different topics associated with the organization, such as information about a transaction conducted via the organization, information about a user account, information on how to perform a transaction via a platform (e.g., a website) provided by the organization, etc.

In some embodiments, the AI model may be configured to provide the requested information to the user via the chat interface. For example, the AI model may be trained using training data that includes various information related to the organization, such that the AI model may generate answers to the users' queries about the organization. However, as the information related to the organization can be constantly changed/updated, it is inefficient to constantly re-train the AI model frequently as training (or re-training) the AI model typically requires a large amount of computer resources and time. As such, in some embodiments, the computer framework may provide a knowledge module (which can be implemented as a computer module, etc.) that is communicatively coupled with the AI model for providing relevant information to the AI model based on user queries. For example, the knowledge module may have access to the information related to the organization (e.g., stored in one or more data storages). In some embodiments, the knowledge module may use a retrieval module to query, from the data storages, a subset of information that is relevant to a user query.

As such, upon receiving an utterance in the form of an inquiry, such as a question or a request, from the user via the chat interface of a user device, the AI model may transmit the utterance to the knowledge module. Based on the utterance, the knowledge module may use the retrieval module to retrieve information (e.g., articles, webpage content, instruction manuals, videos, podcasts, audio, etc.) from the one or more data storages, and may provide the AI model access to the retrieved information.

However, since the utterance received from the user device may be out of context and/or may not include sufficient information for the knowledge module to retrieve the relevant information from the data storages, the knowledge module may include a query reformulator module for reformulating the utterance based on a context associated with the utterance. For example, a user may initially submit an utterance “how do I change password,” and then subsequently asks “how to do it on an iPhone?” Based only on the utterance “how to do it on an iPhone,” the knowledge module may not have sufficient information to retrieve the documents that would be usable by the AI model to answer that particular utterance. As such, the query reformulator module may analyze one or more other utterances that have been exchanged between a user device of the user and the AI-based conversation system, and derive a context based on the other utterance(s). The query reformulator module may only analyze other utterance(s) within a certain time period within the “base” utterance. The query reformulator module may then modify the user query based on the derived context (e.g., incorporating the context into the user query, etc.). In the example illustrated above, the query reformulator module may determine that the utterance is related to changing a password based on analyzing the previous utterance submitted by the user. The query reformulator module may then reformulate (e.g., modify) the utterance from “how to do it on an iPhone” to a reformulated query “how do I change my password on an iPhone.”

The reformulated query may then be used by a retriever module of the knowledge module to retrieve relevant documents from a data storage for the utterance. After retrieving the relevant documents, the knowledge module may then generate a prompt for the AI model. The prompt may include the user utterance (and/or the reformulated query) and the retrieved documents. The knowledge module may provide the prompt to the AI model. In some embodiments, the AI model may be configured and trained to generate content (e.g., a response) in a natural language format to the user inquiry based on the prompt. The AI model may then transmit the response to the inquiry to the user device via the chat interface. In some embodiments, the knowledge module may be implemented using techniques described in U.S. patent application Ser. No. 18/473,989 titled “Knowledge Bot as a Service” to Addanki et al., which is incorporated herein by reference in its entirety.

It has been contemplated that the utterance submitted by the user may include personal information that is unique to the user, and that may not be helpful (or may even be harmful) for the knowledge module in retrieving the relevant information for the AI model. For example, a user may submit an utterance “how do I dispute my recent transaction in the amount of $20?” The information related to the exact amount of the transaction may be relevant to the user, but may neither be relevant nor useful in retrieving documents that can be used to provide an answer to the utterance. This information may even hinder the effort of the retrieval module in retrieving relevant documents for the utterance, as the information related to disputing a transaction that is stored in the data storage would likely not include any specific amount. As such, the knowledge module may configure the query reformulator module to remove any specific type of unnecessary information (e.g., dollar amount for a transaction dispute) from the utterance before providing the reformulated query to the retrieval module for retrieving the relevant information for the AI model.

In some embodiments, the knowledge module stores the removed information in a temporary storage when the query is being processed, such that the removed information may be incorporated back into the response before providing the response to the user. For example, after the AI model generates a response, the knowledge module may incorporate the removed information back into the response. The modified response may include “You can follow the following steps to dispute your recent transaction in the amount of $20 . . . ” By incorporating the removed information back into the response, the response may appear more personalized for the user.

In some embodiments, in addition to providing relevant information associated with the organization to the users, the AI model may also provide additional services, such as processing one or more transactions for the users via the natural dialogues. For example, when the user asks about performing a transaction (e.g., performing a payment transaction, performing a purchase transaction, performing a data access transaction, performing a physical area access transaction, etc.), instead of instructing the user how to initiate the transaction via the platform, the AI model may enable the transaction to be performed for the user, through one or more backend modules that are configured to perform the transaction for the user. As such, in addition to the knowledge module, the computer framework may provide other computer modules (e.g., transaction processing modules) that are configured to perform various transactions for the organization. For an organization that provides online payment services to users, the various backend modules may be configured to perform services related to managing and/or modifying data associated with a user account (e.g., changing passwords, accessing and/or changing personal information, etc.), performing a payment transaction, providing specific content, processing a dispute associated with a transaction, and possibly other transaction services.

Each of the backend modules may be a computer module (e.g., a software module, etc.) that is configured to perform a transaction for the AI model via one or more application programming interfaces (APIs). For example, one or more of the backend modules may be configured to access data storages associated with the organization, and retrieve content (e.g., webpages, articles, instruction manuals, etc.) that are related to a user query. Other backend modules may be configured to process various types of transactions (e.g., a dispute transaction, a payment transaction, a data access transaction, an account management transaction, etc.) for the AI model. In some embodiments, at least some of the backend modules may use services from one or more backend processors for performing the transactions. The backend processors may be associated with the organization or a third-party entity (e.g., a financial institution, etc.).

However, different backend modules may be configured to communicate using different communication protocols (e.g., API calls) and may require different data types or content for processing the corresponding transactions. Furthermore, the organization may add additional backend modules (e.g., to accommodate a new type of transaction service, etc.) and/or modify existing backend modules (e.g., to accommodate a new processing flow, to accommodate a new data type or content requirement, etc.). As such, it can be challenging for the AI model to learn how to (1) generate instructions in the correct format/structure for each backend module and (2) determine what data is required from the user such that the AI model can provide the required data to the backend modules.

To improve the flexibility and scalability of the AI-based conversation system, the computer framework according to various embodiments of the disclosure, may enable different specifications (also referred to as “prompt templates”) corresponding to the different backend modules to be provided to the AI model to facilitate the communications between the AI model and the various backend modules. In some embodiments, the specifications may be stored in a data storage that is separate from the AI-model (e.g., not integrated within the AI model), such that the specifications can be accessible by a user and/or an external module for updating. The specifications may be generated in different formats, such as a text format, an XML format, a JSON format, etc. In some embodiments, a specification may be generated for each backend module.

Each specification may include information related to how to communicate with the corresponding backend module. For example, each specification may include a description of the backend module (e.g., the transaction type that the corresponding backend module is capable of performing), one or more API calls usable for communicating with the corresponding backend module, the functionality (e.g., an expected result) for each API call, a list of input parameters (e.g., required parameters, optional parameters, etc.) for each API call, and other information. In some embodiments, each specification includes information that is usable by the AI model to generate (1) one or more questions for prompting the user for any missing information that is required for performing the transaction and (2) instructions (e.g., one or more API calls) for the backend module to perform the transaction. For example, a specification corresponding to a backend module that is configured to process a payment transaction may specify one or more API calls for instructing the backend module to process a specific payment transaction. The specification may also specify various input parameters for the API calls, where the input parameters correspond to various data types or content that are required by the backend module to process the payment transaction, such as information associated with a funding source, an identity of a recipient, etc.

In some embodiments, in order to improve the efficiency of the AI-based conversation system, the computer framework may provide a conversation management module within the AI-based conversation system for selecting a specification and providing the specification to the AI model based on a user request, such that the frequency of using the AI model (which typically consumes substantially more computer processing power and time than other computer modules) can be reduced. The conversation management module may be coupled to the chat interface, the AI model, and the data storage that stores the specifications within the AI-based conversation system. Thus, when the AI-based conversation system receives an utterance (e.g., text or voice) from the user via the chat interface, the conversation management module may analyze the utterance to determine or predict an intent of the user. When the conversation manager module determines that the utterance is associated with a request for processing a transaction (e.g., accessing/changing user data associated with an account, processing a payment transaction, processing a dispute, etc.), the conversation management module may determine a backend module that is capable of performing the requested type of transaction for the user based on the request. The conversation management module may then retrieve, from the data storage, the specification that corresponds to the backend module, and provide the utterance from the user and the specification to the AI model (e.g., as a prompt for the AI model). In some embodiments, based on the prompt, the AI model may determine the data types or content that are required by the corresponding backend module. The AI model may generate an API call template based on the specification. The API call template may include the name of the API call, and all of the input parameters required by the API call. In some embodiments, the API may initialize the input parameters with a placeholder value (e.g., a null value, etc.). The AI model may then attempt to fill the input parameters with actual value based on the user request (e.g., the utterance received from the user).

In some embodiments, the AI model may analyze the request and may extract data from the request that is usable for the API call. For example, when the user submits the utterance “I would like to send a payment to John Smith,” the AI model may extract the name “John Smith” and generate a value (e.g., an account number of an account corresponding to John Smith, etc.) for the input parameter corresponding to the recipient of the transaction for the API call. The AI model may review the API call template, and may determine if any data is missing in the API call template. In this example, the AI model may determine that a payment amount and information associated with a funding source is missing in the API call template. As such, the AI model may generate content that asks the user for the payment amount and funding source information. For example, the AI model may generate an utterance “How would you like to pay John Smith and for how much?”

In some embodiments, before generating the content that asks the user for the missing information, the AI model may also retrieve additional information about the user (e.g., funding source information that has been provided by the user to the organization previously). For example, the AI model may generate instructions (e.g., API calls) to another backend module (e.g., the backend module that is configured to access user information) to retrieve information of one or more funding sources associated with the user. The AI model may then generate the content to ask the user to confirm which of the funding sources that the user would like to use for paying John Smith.

The AI model may be required to facilitate multiple dialogues with the user in order to obtain all of the data required for the API call. For example, when multiple data types or content in the API call template are missing, the AI model may generate multiple utterances to ask the user to provide data corresponding to the multiple data types or content. In another example, the user may not provide any useful data for the transaction or provide the wrong type of data after an initial attempt, and the AI model may be required to repeat the utterance or generate another utterance to ask for the same type of data (e.g., asking the question in a different way, using different words or phrases, etc.) before obtaining the correct data for the API call template.

Once the AI model determines that all of the input parameters in the API call template have been filled, the AI model may generate the API call based on the API call template. The AI model may also transmit the API call (that includes all of the input parameters) to the backend module for processing the transaction. After processing the transaction based the API call, the backend module may transmit an output to the AI model (e.g., one or more return values from the API call, etc.). The output may indicate whether the transaction has been processed successfully (e.g., whether the transaction has been authorized or declined, whether information that is requested in the API call is available, etc.) or whether additional information from the user is required to complete the transaction. The AI model may generate content based on the output from the backend module, and may transmit the content to the user via the chat interface. For example, if the payment transaction for John Smith has been successfully processed, the AI model may generate an utterance “The payment to John Smith has been successfully processed,” and transmit the utterance to the user. If the output indicates that additional information is required, the AI model may generate content that prompts the user for the additional information.

The separation of the communication protocols associated with the backend modules from the AI model enables the AI-based conversation system to be more flexible and scalable. For example, when a new backend module is integrated within the AI-based conversation system, the organization may simply generate a new specification for the new backend module, and add the new specification to the data storage. The organization may also configure the conversation management module to recognize a new transaction type corresponding to the new backend module such that the conversation management module may select the new specification for providing to the AI module when a user utterance that is associated with the new transaction type is received by the AI-based conversation system. In another example, when a backend module is modified (e.g., requiring different input parameters, different API call formats, etc.), the organization may amend the specification associated with the backend module based on the modification. As such, no changes (e.g., modification to the parameters of the AI model) or re-training to the AI model is necessary to accommodate any expansion and/or modification to the backend modules.

The inclusion of the conversation management module may provide additional benefits for the AI-based conversation system. In some embodiments, the conversation management module may perform additional processing to the utterances from the user before providing the processed utterances to the AI model, and perform additional processing to the content generated by the AI model before providing the processed content to the user. For example, the conversation management module may perform translation services to the utterance/content. When the conversation management module detects that the language used in the utterance submitted by a user does not correspond to the particular language used by the AI model, the conversation management module may first translate the utterance from the original language to the particular language, and may pass the translated utterance to the AI model. Similarly, when the conversation management module receives content (e.g., a response utterance, etc.) from the AI model in the particular language that is intended for the user, the conversation management module may translate the response utterance from the particular language to the language used by the user before passing the translated content to the user via the chat interface.

The conversation management module may also perform content moderation services to the utterances. For example, when the conversation management module detects that the utterance submitted by a user does not correspond to any question or transaction type associated with the organization (e.g., questions or requests that are not related to the organization), the conversation management module may automatically respond with a pre-generated message, such as “we cannot help you with this request,” without passing the utterance to the AI model. This way, computer processing resources can be preserved as the AI model does not need to process unnecessary requests from the users.

In some embodiments, the conversation management module may also perform data sanitization services on the utterances. For example, the conversation management module may remove any words or phrases from the utterance submitted by the user that are not useful or needed for the AI model to generate an answer (e.g., redundant words, words or phrases that are not related to an intent detected by the conversation management module, offensive languages, etc.). By removing unnecessary words or phrases before passing the utterances to the AI model for processing, the conversation management module further preserves the computer processing resources that are consumed by the AI model.

In some embodiments, the conversation management module may perform these services to the utterances by executing one or more external tools (e.g., other software modules). The tools (e.g., the executable software modules) may be stored within a storage area (e.g., a data storage or a folder on a device, etc.) that is accessible by the conversation management module. The separation of logic for performing the services from the conversation management module further improves the flexibility and scalability of the AI-based conversation system. For example, the tools within the storage area may be updated without requiring any modification and/or re-compiling of the conversation management module. In some embodiments, the computer framework may also provide, to the conversation management module, tool execution information that specifies the logic for executing different tools for different situations (e.g., different attributes associated with the utterances). For example, the tool execution information may specify the execution of a translation tool when an utterance is detected to be in a different language than the one used by the AI model. The tool execution information may also specify the execution of a data sanitization tool for all utterances. The tool execution information may be saved in a separate file, such as a text file, an XML file, a JSON file, etc., such that the logic can also be modified without requiring any changes to the conversation management module. When the conversation management module receives an utterance, the conversation management module may access the tool execution information, and execute one or more tools according to the tool execution information. This way, the tools can be provided to the conversation management module in a plug-and-play manner. For example, when a tool is added to the storage area (e.g., a new process for processing utterances is generated, etc.) or removed from the storage area (e.g., an old process is no longer needed for the AI-based conversation system, etc.), only the tool execution information is required to be modified.

As such, when the AI-based conversation system receives an utterance from the user (or from the AI model), the conversation management module may analyze the utterance to detect one or more attributes (e.g., the language used in the utterance, an intent detected, an origin of the utterance, etc.). The conversation management module may then access the tool execution information, and execute one or more tools from the storage area based on the one or more attributes associated with the utterance and according to the tool execution information.

As discussed herein, the AI-based conversation system may conduct conversations with various users in different chat sessions. The AI-based conversation system may use the AI model to provide different information related to the organization to the users, and may also process different transactions for the users. One aspect of maintaining the AI-based conversation system is to evaluate the performance of the different components of the AI-based conversation system such that the different components can be improved over time. However, unlike other machine learning models where a predicted outcome/result can be subsequently verified (e.g., using ground truths), it can be a challenge to determine the quality of the utterances and the instructions generated by the AI model.

In some embodiments, the computer framework may provide and configure an evaluation module to evaluate the performance of the AI-based conversation system. The evaluation module of some embodiments may evaluate the performance of the AI-based conversation system based on a set of metrics. The set of metrics may correspond to different characteristics of the content generated by the AI model and/or the overall conversation conducted by the AI model. For example, the set of metrics may include one or more metrics that measure the quality of utterances provided by the user, one or more metrics that measure the quality of each content generated by the AI model and provided to a user, one or more metrics that measure the quality of the instructions generated by the AI model for one or more backend modules, and one or more metrics that measure the quality of the overall conversation between the AI-based conversation system and the user.

In order to evaluate each content, the evaluation module may generate (or otherwise obtain) benchmark content associated with various topics, such that the quality of content generated by the AI model can be determined based on comparing the content against a corresponding benchmark content. The content generated by the AI model can be divided into at least two categories. For example, a first category may be related to answers generated by the AI model in response to inquiries submitted by users and a second category may be related to prompts generated by the AI model for obtaining information from the users. Additional categories can also be contemplated, such as instructions generated by the AI model for other computer modules, etc. In some embodiments, the evaluation module may generate various benchmark content related to different potential inquiries that can be submitted by users (e.g., utterances that provide different information associated with the organization), and various benchmark contents related to prompting users for different information based on the specifications associated with the backend modules.

When the evaluation module receives content generated by the AI model (e.g., during a chat session, etc.), the evaluation module may first determine a semantic quality of the content by comparing the meaning of the content generated by the AI model against the meaning of the corresponding benchmark content. For example, the evaluation module may use a machine learning model to derive a set of vectors based on the content generated by the AI model, and also use the machine learning model to derive a set of vectors based on the corresponding benchmark content. The evaluation module may then compare the two sets of vectors to determine a semantic similarity between the AI model-generated content and the benchmark content.

If the content is generated by the AI model in response to a question submitted by a user, the evaluation may indicate how well the content answers the question. If the content is generated by the AI model to prompt the user for specific information, the evaluation may indicate whether the content prompts the user for the correct type of information.

In some embodiments, the evaluation module may also evaluate a syntactical quality of each content. The syntactical quality of a content can be measured by a tone, a choice of words/phrases, a clarity, and/or a conciseness of the utterance, beside other characteristics. For example, the evaluation module may determine a preferred syntactical quality for the content generated by the AI model, based on factors such as an identity and attributes (e.g., an age, a location, etc.) of the user for which the utterance is intended, a tone of other utterances submitted by the user, and a responsiveness of the user during prior exchanges (e.g., previous turns of dialogues between the AI model and the user, etc.). The evaluation module may then determine how similar is the syntactical quality of the content generated by the AI model to the preferred syntactical quality.

In some embodiments, the evaluation module may also determine the syntactic quality of the content based on an utterance submitted by the user after the content is provided to the user. For example, if the user does not provide the correct type or content of data as prompted by the AI module, the evaluation module may determine that the syntactical quality of the content is low. The evaluation module may also determine whether to improve the content based on the syntactic quality. For example, if it is determined that the syntactical quality of the content is below a threshold, the evaluation module may cause the AI model to generate another inquiry for prompting the user for the same type of data using a different syntax or wording.

In some embodiments, the evaluation module may also evaluate the quality of the overall conversation between the AI model and the user during a chat session. The evaluation module may determine the conversation metric for the conversation based on a number of factors, such as a number of dialogue turns between the AI model and the user. A conversation between the AI model and the user may include multiple dialogue turns, where each dialogue turn includes a pair of exchanges between the user and the AI model (e.g., one or more utterances from the user and one or more responses from the AI model). The number of dialogue turns may indicate how successful the AI model is in communicating the necessary information (or questions) to the user. In some embodiments, the evaluation module may evaluate the quality of the overall conversation based on the number of dialogue turns required to complete a transaction (e.g., when the user has obtained the information being requested or when a transaction has been successfully processed by the backend modules, etc.).

The evaluation module may perform such an evaluation over different content generated by the AI model and/or over different conversations with the users of the organization. In some embodiments, based on evaluating the AI-based conversation system, the evaluation may be configured to perform one or more actions for different components of the AI-based conversation system to further improve the performance of the AI-based conversation system. For example, if it is determined that the quality of the content generated by the AI model is below a threshold, the evaluation module may adjust one or more parameters of the AI model such that the way that the AI model interprets a user question and/or the way that the AI model generates content is modified. In another example, if it is determined that an average number of dialogue turns exceeds a threshold, the evaluation model may determine that the AI model takes too many dialogue turns to obtain the necessary information from the users. This can be due to an internal deficiency within the AI model (e.g., the lack of ability to generate a good question, etc.) or problems related to the specifications associated with the backend modules. As such, the evaluation module may adjust one or more parameters of the AI model and/or modify one or more specifications associated with the different backend modules.

In some embodiments, after evaluating the different conversations that the AI-based conversation system conducted with various users, the evaluation module may select some of the content generated by the AI model that are determined to have qualities below the threshold, and may use such content to re-train the AI model. For example, the evaluation module may generate or obtain (from a human reviewer or from another module) content that performs the same function as the selected content generated by the AI model, and may re-train the AI model using the newly generated/obtained utterance. In another example, the evaluation module may use the AI model-generated content to perform a negative feedback training for the AI model (e.g., by labeling the content with a poor score, etc.).

By systematically evaluating the outputs generated by the AI-based conversation system and adjusting the different components within the AI-based conversation system, the evaluation module may continue to improve the performance of the AI-based conversation system.

In some embodiments, in order to further enhance the speed performance and computer resource efficiency of the AI-based conversation system, the computer framework provides a cache system for storing utterances for the AI-based conversation system. Since the AI model typically consumes a substantial amount of computer processing resources and time to dynamically generate content (e.g., responses to user questions, prompts for users, etc.), caching frequently used/requested content can substantially improve the response time and computer resource efficiency of the AI-based conversation system. In some embodiments, the cache system stores frequently used/requested content in a memory (e.g., a SRAM, a DRAM, etc.). When a new utterance is submitted by a user, the cache system may determine whether the utterance submitted by the user corresponds to a request for any of the content stored in the cache memory. If a match exists, the cache system may retrieve corresponding content from the cache memory, and the conversation management module may transmit the corresponding content to the user via the chat interface, without using the AI model to process the new utterance, thereby reducing the amount of time (and the required computer processing resources) to respond to the user's utterance.

In some embodiments, the cache system may include a multi-tiered structure, where each tier includes a different type of cache module for caching/querying data. For example, a two-tiered structure can include a first cache module (in a first tier) that is associated with a lower cost (e.g., a lower consumption of computer processing resources, etc.) and lower accuracy cache querying structure, such as a lexical querying structure, and a second cache module (in a second tier) that is associated with a higher cost (e.g., a higher consumption of computer processing resources, etc.) and higher accuracy cache querying structure, such as a semantic querying structure. However, the use of three or more cache tiers is contemplated, each with different cost, accuracy levels, etc.

In some embodiments, the first cache module uses words from the user's utterance to determine whether the user's utterance results in a cache hit. For example, the first cache module may store utterances that were previously submitted by users as keys in a cache storage of the first cache module. In some embodiments, hash values of the utterances (e.g., generated using one or more hash algorithms, etc.) can be used as keys instead of the actual utterances. The responses that were generated by the AI model and provided to the user devices in response to the utterances are stored as corresponding values in the cache storage of the first cache module. When a new utterance is received from a user device, the first cache module may determine whether the utterance matches any of the keys in the cache storage of the first cache module. If a match (e.g., an exact match, a fuzzy match, etc.) of the utterance is found in the cache storage, the first cache module may determine that a cache hit has occurred, and return the value corresponding to the matched key from the cache storage of the first cache module as a response to the user utterance without requiring the AI model to process the utterance.

In some embodiments, instead of storing the entire utterances as keys for the cache storage, the first cache module extracts keywords from each of the utterances as keys in the cache storage of the first cache system. When the new utterance is received, the first cache module may extract one or more keywords from the new utterance and determine whether the keywords extracted from the utterance match any keys in the cache storage. When the extracted keywords match a key in the cache storage (a cache hit), the corresponding value may be retrieved and provided to the user device as a response to the utterance without requiring the AI model to process the utterance.

While querying the cached contents using the first cache module (e.g., a lexical cache system) can be fast, it may produce a high level of cache misses (e.g., exceeding a threshold) because utterances submitted by the users can be worded very differently, even if they have substantially the same meaning. For example, while these two utterances “how to reset my password” and “how to change my account credentials” include very different words, they have a very similar meaning, and a similar response should be provided for responding to these two utterances. However, since the two utterances use different words to describe a similar question, they will not produce a match in the first cache module even though one of the utterances and the corresponding response is stored in the cache storage of the first cache module.

As such, the cache system may include a semantic cache (the second cache module) in the second tier of the cache system. Instead of using the words in the utterance to determine a match, the second cache module derives a meaning of the words in the utterance, and uses the meaning to determine a match. For example, the second cache module may store embeddings (e.g., vector representations) derived from previously submitted utterances as keys in a cache storage of the second cache module. Each embedding may be implemented as a vector in a multi-dimensional space, where each dimension represents a distinct aspect. In some embodiments, a machine learning model (e.g., the AI model) is used by the second cache model to generate the embeddings for each utterance. The embeddings derived for each utterance represent the semantic meaning associated with the utterance that is not bound by the actual words used in the utterance. As such, embeddings that are generated from two different utterances that include different wordings, but carry similar meanings, may be close with each other (e.g., within a threshold distance) within the multi-dimensional space. Similar to the first cache module, the responses that were generated by the AI model and provided to the user devices in response to the utterances are stored as corresponding values in the cache storage of the second cache module.

When the new utterance results in a cache miss in the first cache module, the utterance is provided to the second cache module. The second cache module may generate embeddings based on analyzing the words in the utterance, and determine whether the utterance matches any of the keys in the cache storage of the second cache module based on the embeddings. For example, the second cache module may determine that the utterance matches a key in the cache storage when the embeddings of the utterance are within a threshold distance from the key in the cache storage. Since the embeddings represent the semantic meaning of the utterance independent of the words used in the utterance, the utterance may be matched with a previously submitted utterance as long as their meanings are similar, even though different words were used in the previously submitted utterance. If a match of the utterance is found in the cache storage, the second cache module may determine that a cache hit has occurred, and return the value corresponding to the matched key from the cache storage of the second cache module as a response to the user utterance without requiring the AI model to process the utterance. Since the second cache module attempts to match the user-submitted utterances to cached contents based on the actual meanings (instead of the words) of the utterances, the second cache module would produce cache hits for utterances that resulted in cache misses in the first cache module.

In some embodiments, the cache system includes more than two tiers of cache modules (e.g., 3, 5, 8, etc.), where each cache module may be implemented using a different cache query structure such that an utterance that resulted in a cache miss(es) in one or more lower tiers of cache module may produce a cache hit in a higher tier of cache module. When a cache hit occurs in a cache module, in addition to returning the response obtained from the cache module based on the cache hit to the requesting device (e.g., the device that submitted the utterance), the cache system may update the cache storage(s) of one or more lower tiers of cache modules. If the cache hit occurs in the second cache module, the cache system may update the first cache module using the response retrieved from the second cache module. On the other hand, if the cache hit occurs in a third cache module (e.g., a third tier in the multi-tier structure of the cache system) that comes after the second cache module, the cache system may update the first cache module and the second cache module using the response retrieved from the third cache module.

For example, if the utterance resulted in a cache hit in the second cache module, the cache system may update the cache storage of the first cache module based on the response retrieved from the cache storage of the second cache module. The cache system may add a new cache record (e.g., a key-value pair) in the cache storage of the first cache module. The cache system may store the utterance (or keywords extracted from the utterance) as a new key in the new cache record of the cache storage of the first cache module, and may store the response retrieved from the second cache module as a new value in the new cache record of the cache storage of the first cache module.

When the utterance results in cache misses in all of the cache modules of the cache system, the conversation management module may provide the utterance to the AI model, and use the AI model to generate a response. In addition to providing the response to the requesting device (e.g., the device that submitted the utterance), the cache system may also obtain the response and update all of the cache modules based on the response. For example, the cache system may update the cache storage of the first cache module based on the response generated by the AI model. The cache system may add a new cache record (e.g., a key-value pair) in the cache storage of the first cache module. The cache system may store the utterance (or keywords extracted from the utterance) as a new key in the new cache record of the cache storage of the first cache module, and may store the response generated by the AI model as a new value in the new cache record of the cache storage of the first cache module.

The cache system may also update the cache storage of the second cache module based on the response generated by the AI model. The cache system may add a new cache record (e.g., a key-value pair) in the cache storage of the second cache module. The cache system may store the embeddings generated based on the utterance as a new key in the new cache record of the cache storage of the second cache module, and may store the response generated by the AI model as a new value in the new cache record of the cache storage of the second cache module. The cache system may also update the cache storage(s) of other cache module(s) of the cache system.

One of the advantages of having the multi-tier structure for the cache system as disclosed herein is that the cache modules are modular. In other words, each of the cache modules in the cache system can be removed or exchanged with another cache module, or a new cache module can be integrated within the cache system seamlessly. The cache system may work with any number of cache modules within this framework as disclosed herein. The cache system would follow the order in the tiered structure to retrieve cached responses when a new utterance is received, and would update the cache modules accordingly. This way, updates to the cache system can be performed seamlessly, and any new cache techniques can be incorporated into the cache system seamlessly by adding a new cache module or replacing an existing cache module with the new cache module.

Since the cache storages of the cache modules are inherently limited in capacity, the cache system uses a time-to-live (TTL) methodology to ensure that responses that are not used/requested frequently are removed from the cache storage(s) such that newly generated responses that are used/requested frequently can be adequately cached, which further enables more efficient memory usage or storage. Every cache record stored in a cache storage is associated with a TTL that indicates an expiration time of the cache record. The cache system (or each cache module) may monitor the TTL of the cache records in the cache storages, and may automatically remove (e.g., delete) the cache records that have expired based on their corresponding TTL. In some embodiments, when a response is added to a cache storage (e.g., as a new cache record, etc.), the response (or the new cache record) is assigned a predetermined maximum TTL (e.g., 24 hours, one week, etc.). At the end of the TTL period, the cache record would be removed from the cache storage. However, if the cache record is accessed based on a cache hit (e.g., the response in the cache record is retrieved as a cache hit for an utterance, etc.), the corresponding cache module may update the TTL of the cache record (e.g., extend the TTL to the predetermined maximum TTL, etc.). This way, cache records that are used/requested frequently would remain in the cache storage(s), while cache records that are not frequently used/requested would be removed to provide memory space for new cache records.

Unlike other artificial intelligence system, the AI model of the AI-based conversation system generates responses not only based on utterances provided by users, but also information (e.g., documents, etc.) retrieved by the retrieval module based on the utterances. As discussed herein, when an utterance is received by the knowledge module, the knowledge module may use a retrieval module to retrieve information (e.g., (e.g., articles, webpage content, instruction manuals, videos, podcasts, audio, etc.) that is related to the utterance. The knowledge module may provide both the utterance and the retrieved information to the AI model, such that the AI model may generate a response to the utterance using content from the retrieved information.

It has been contemplated that the information from the data storage(s) may be changed over time (e.g., replaced, modified, etc.) based on different factors, such as a change of an internal process, a change of policy, etc. When the underlying information that the responses are based on becomes outdated (e.g., has been modified and/or replaced with new information, etc.), the responses that are stored in the cache storage(s) are no longer accurate, and should not be returned and/or provided to users as responses to utterances. To ensure that only accurate and updated responses are provided by the AI-based conversation system, the cache system needs to make sure that responses that were generated based on outdated information would not be used, and be removed from the cache storage(s). In one approach, the cache system may check the responses (e.g., periodically, etc.) and remove the responses that were generated by outdated underlying information from the cache storage(s). However, such an approach is both time consuming and requires substantial computer processing resources as it requires analyzing the underlying documents used to generate each response stored in the cache storage(s) repeatedly (e.g., periodically, etc.).

In another approach, the cache system may provide an invalidation mechanism that ensures that a cache hit would occur only when the response corresponding to the matched key was generated using updated information. In this regard, when the utterance is provided to the cache system, the cache system may also access the information (e.g., a set of documents) that were retrieved to be used potentially by the AI model to generate a response for the utterance. The information that was retrieved by the retrieval module based on the utterance may have been updated since the last time the information was used by the AI model to generate a response. If the information has been updated, any response that is stored in the cache storage and that was generated using the outdated information would not be accurate, and should not be used by the AI-based conversation system.

As such, when a cache module (e.g., the first cache module, the second cache module, etc.) of the cache system determines that the utterance matches a key in the cache storage, the cache module may also determine whether the information accessed by the cache system and associated with the utterance is identical (or within a threshold similarity) to the underlying information used by the AI model to generate the response stored in the cache storage and corresponding to the matched key. If the information has been updated, the information retrieved by the retrieval module for the utterance would be different from the underlying information used to generate the response that is stored in the cache storage. Thus, the cache module would only determine a cache hit for the utterance when the utterance matches a key in the cache storage, and the information that is associated with the utterance is identical (or within a threshold similarity) to the underlying information used to generate the response in the cache storage. In other words, the cache module would determine a cache miss even when the utterance matches a key in the cache storage, if the underlying information is different.

In some embodiments, the cache system may use a hash generator to generate a hash value based on the information used to generate a response. When a response is added to the cache storage, the cache module may store a key (e.g., the utterance, one or more keywords, the embeddings) associated with the utterance and a corresponding response as a new cache record in the cache storage. The cache module may also store the hash value generated based on the underlying information used to generate the response in the new record. When an utterance is received by the cache system, the cache system may access the information retrieved by the retrieval module based on the utterance. The cache system may also use a hash generator to generate a hash value based on the information, and may provide the utterance along with the hash value to the cache module(s). If a cache module determines that the utterance matches a key in the cache storage, the cache module may also perform a secondary check to determine whether the hash value generated based on the newly retrieved information matches the hash value stored in the cache record associated with the key. If the underlying information used to generate the response stored in the cache record has been modified, the hash value that is generated based on the newly retrieved information would be different from the hash value that was generated based on the outdated information. Thus, the cache module may determine that a cache hit has occurred and return the response in the cache record only when the hash values also match.

Using the invalidation mechanism as disclosed herein, responses that are stored in the cache storage and that were generated using outdated information would no longer be retrieved and provided as responses to user utterances, since the cache modules are configured to determine a cache miss when the underlying information used to generate the response in the cache storage is outdated. Due to the TTL associated with the cache records that store these outdated responses, the cache records will be removed from the cache storage(s) at the expiration time specified by the TTL. As discussed herein, even when an utterance matches the key of an outdated cache record, the cache module would not determine a cache hit (in other words, would determine a cache miss) due to the discrepancy between the underlying information. Based on the cache miss(es) from the cache module, the conversation management module may use the AI model to re-generate a response using the up-to-date information retrieved by the retrieval module for the utterance. The re-generated response would then be stored in the cache storage(s) in association with the utterance. When the same (or similar) utterance is subsequently received, the cache module may determine a cache hit based on the more updated cache record (and not the outdated cache record), and may return the re-generated response stored in the updated cache record.

Since the responses generated by the AI model and provided to users are in a natural language format, different types of users may have different preferences in the way that the responses are constructed (e.g., some users prefer short and concise responses while others prefer lengthy responses with more details, different users may prefer different tone, different users may prefer different languages or different choice of words, etc.). When the knowledge module instructs the AI model to generate a response to an utterance provided by the user, the knowledge module may also provide instructions related to the desired characteristics in the response (e.g., lengthy vs. concise, a specific language, choice of words that are specific to a particular geographical region, tone, etc.). In some embodiments, when the response is inserted into one or more cache storages of one or more cache modules, the cache system may also store additional data that represents the different characteristics of the corresponding response in the cache records. For example, the additional data may indicate a language (e.g., English, Spanish, German, Chinese, etc.), a specific locale (e.g., United States, England, Scotland, etc.), a specific tone (e.g., professional, casual, etc.), and other characteristics. In some embodiments, the cache system may generate a hash value based on all of the characteristics, and store the hash value in the cache record.

When a new utterance is received, the cache system may determine additional information associated with the user and/or the user device used to submit the utterance. For example, the cache system may determine that the user device is located in a particular geographical region (e.g., a particular country, a particular state, etc.), the utterance is in a particular language, the attributes associated with the user (e.g., a user profile associated with the user, which may include prior chat sessions), etc. The cache system may then determine desired characteristics for a response to the utterance based on the additional information. For example, the cache system may determine a language to match the language used in the utterance, determine the choice of words based on the locale associated with the user device, determine the tone and other characteristics based on the user profile, etc. The cache system may also generate a hash value based on these characteristics.

The cache system may provide the characteristics, along with the utterance and the information retrieved by the retrieval module, to the cache module(s). When a cache module determines that the utterance matches a key in the cache storage, the cache module may also determine whether the underlying information used to generate the corresponding response is identical (or within a threshold similarity) to the information retrieved by the retrieval module, and may determine whether the characteristics of the response match the desired characteristics. The cache module would only determine that a cache hit occurs and returns the response in the cache record associated with the matched key when the underlying information used to generate the corresponding response is identical (or within a threshold similarity) to the information retrieved by the retrieval module, and characteristics of the response match the desired characteristics. As such, even when the utterance matches a key in the cache storage, indicating that a response corresponding to the key can be used as a response to the utterance, the cache module would issue a cache miss and would not return the response if the characteristics of the response do not match the desired characteristics (e.g., the language used in the response is different from the language used in the utterance, the tone used in the response is different from the desired tone, etc.). This way, it can be ensured that the responses being provided to the users through the cache system are personalized for the users.

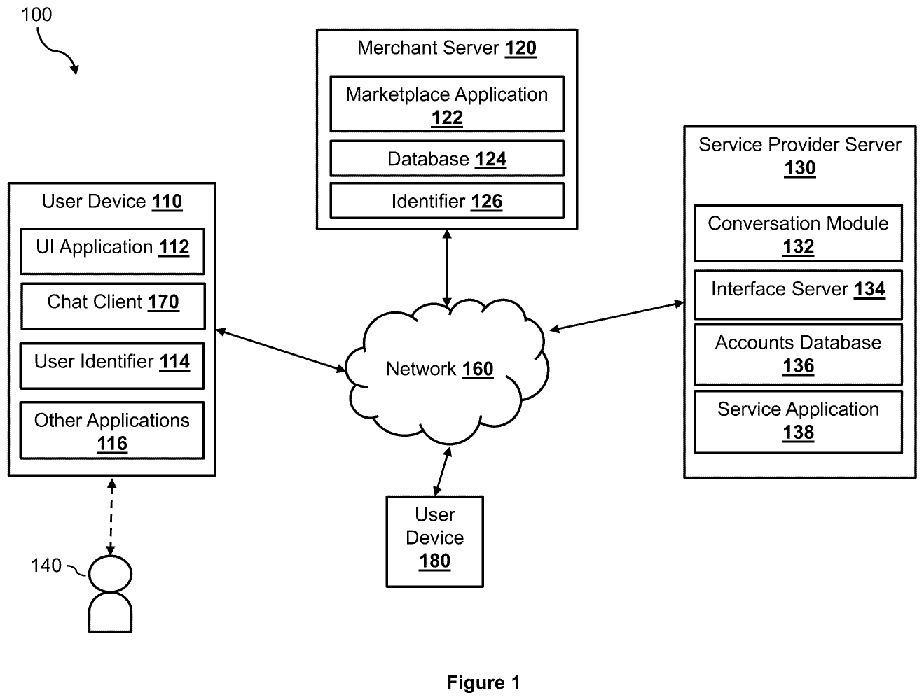

FIG. 1 illustrates an electronic transaction system 100, within which the AI-based conversation system may be implemented according to one embodiment of the disclosure. The electronic transaction system 100 includes a service provider server 130, a merchant server 120, and user devices 110 and 180 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140 to interact with the merchant server 120 and/or the service provider server 130 over the network 160. For example, the user 140 may use the user device 110 to conduct an online purchase transaction with the merchant server 120 via websites hosted by, or mobile applications associated with, the merchant server 120. The user 140 may also log in to a user account to access account services or conduct electronic transactions (e.g., data access, account transfers or payments, etc.) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface (UI) application 112 (e.g., a web browser, a mobile payment application, etc.), which may be utilized by the user 140 to interact with the merchant server 120 and/or the service provider server 130 over the network 160. In one implementation, the user interface application 112 includes a software program (e.g., a mobile application) that provides a graphical user interface (GUI) for the user 140 to interface and communicate with the service provider server 130 and/or the merchant server 120 via the network 160. In another implementation, the user interface application 112 includes a browser module that provides a network interface to browse information available over the network 160. For example, the user interface application 112 may be implemented, in part, as a web browser to view information available over the network 160. Thus, the user 140 may use the user interface application 112 to initiate electronic transactions with the merchant server 120 and/or the service provider server 130.

The user device 110 may also include a chat client 170 for facilitating online chat sessions with another chat client (e.g., a chat client of another device, such as the user device 180, the conversation module 132 of the service provider server 130, etc.). The chat client 170 may be a software application executed on the user device 110 for providing a chat client interface for the user 140 and for exchanging (e.g., transmitting and receiving) messages with the other chat client (either via a peer-to-peer chat protocol or via a chat server). For example, during an online chat session with the conversation module 132, the chat client 170 may present a chat interface that enables the user 140 to input data (e.g., text data such as utterances, audio data, multi-media data, etc.) for transmitting to the conversation module 132. The chat interface of the chat client 170 may also present messages that are received from the conversation module 132. In some embodiments, the messages may be presented on the chat client interface in a chronological order according to a chat flow of the online chat session. The chat client 170 may be an embedded application that is embedded within another application, such as the UI application 112. Alternatively, the chat client 170 may be a stand-alone chat client program (e.g., a mobile app such as WhatsApp®, Facebook® Messenger, iMessages®, etc.) that is not associated with any other software applications executed on the user device 110.

The user device 110, in various embodiments, may include other applications 116 as may be desired in one or more embodiments of the present disclosure to provide additional features available to the user 140. In one example, such other applications 116 may include security applications for implementing client-side security features, programmatic client applications for interfacing with appropriate application programming interfaces (APIs) over the network 160, and/or various other types of generally known programs and/or software applications. In still other examples, the other applications 116 may interface with the user interface application 112 and/or the chat client 170 for improved efficiency and convenience.

The user device 110, in one embodiment, may include at least one identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile).

In various implementations, the user 140 is able to input data and information into an input component (e.g., a keyboard) of the user device 110. For example, the user 140 may use the input component to interact with the UI application 112 (e.g., to conduct a purchase transaction with the merchant server 120 and/or the service provider server 130, to initiate a chargeback transaction request, etc.). In another example, the user 140 may use the input component to interact with the chat client 170 (e.g., to provide utterances to be transmitted to other chat clients, to a chat server, etc.). The user 140 may transmit questions/inquiries, and/or requests for performing certain tasks/transactions using the input component. In some embodiments, if the chat client 170 is integrated within another application (e.g., the UI application 112, etc.), the chat client may automatically access account data of the user via a platform (e.g., a website, etc.) accessed by the UI application, and may provide the relevant account data to another chat client or a chat server for performing the tasks/transactions.

The user device 180 may include substantially the same hardware and/or software components as the user device 110, which may be used by a user to interact with the merchant server 120 and/or the service provider server 130.

The merchant server 120, in various embodiments, may be maintained by a business entity (or in some cases, by a partner of a business entity that processes transactions on behalf of the business entity). Examples of business entities include merchants, resource information providers, utility providers, online retailers, real estate management providers, social networking platforms, a cryptocurrency brokerage platform, etc., which offer various items for purchase and process payments for the purchases. The merchant server 120 may include a merchant database 124 for identifying available items or services, which may be made available to the user devices 110 and 180 for viewing and purchase by the respective users.

The merchant server 120, in one embodiment, may include a marketplace application 122, which may be configured to provide information over the network 160 to the user interface application 112 of the user device 110. In one embodiment, the marketplace application 122 may include a web server that hosts a merchant website for the merchant. For example, the user 140 of the user device 110 (or the user of the user device 180) may interact with the marketplace application 122 through the user interface application 112 over the network 160 to search and view various items or services available for purchase in the merchant database 124. The merchant server 120, in one embodiment, may include at least one merchant identifier 126, which may be included as part of the one or more items or services made available for purchase so that, e.g., particular items and/or transactions are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

While only one merchant server 120 is shown in FIG. 1, it has been contemplated that multiple merchant servers, each associated with a different merchant, may be connected to the user device 110 and the service provider server 130 via the network 160.

The service provider server 130, in one embodiment, may be maintained by a transaction processing entity or an online service provider, which may provide processing of electronic transactions between users (e.g., the user 140 and users of other user devices, etc.) and/or between users and one or more merchants. As such, the service provider server 130 may include a service application 138, which may be adapted to interact with the user device 110 and/or the merchant server 120 over the network 160 to facilitate the electronic transactions (e.g., electronic payment transactions, data access transactions, etc.) among users and merchants processed by the service provider server 130. In one example, the service provider server 130 may be provided by PayPal®, Inc., of San Jose, California, USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions between a user and a merchant or between any two entities (e.g., between two users, between two merchants, etc.). In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user devices 110 and 180 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various services provided by the service provider server 130. The interface server 134 may also include other electronic pages associated with the different services (e.g., electronic transaction services, etc.) offered by the service provider server 130. As a result, a user (e.g., the user 140, the user of the user device 180, or a merchant associated with the merchant server 120, etc.) may access a user account associated with the user and access various services offered by the service provider server 130, by generating HTTP requests directed at the service provider server 130.

The service provider server 130, in one embodiment, may be configured to maintain one or more user accounts and merchant accounts in an accounts database 136, each of which may be associated with a profile and may include account information associated with one or more individual users (e.g., the user 140 associated with user device 110, the user associated with the user device 180, etc.) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions. It is noted that the accounts database 136 (and/or any other database used by the system disclosed herein) may be implemented within the service provider server 130 or external to the service provider server 130 (e.g., implemented in a cloud, etc.).

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

In various embodiments, the service provider server 130 also includes a conversation module 132 that implements the AI-based conversation system as discussed herein. In some embodiments, the conversation module 132 may provide a user interface on devices (e.g., the user device 110, the user device 180, the merchant server 120, etc.) that enables users to submit utterances, such as questions related to an organization associated with the service provider server 130, requests for performing a transaction, etc. For example, the conversation module 132 may include or have access to a chat server (not shown) that can facilitate and maintain chat sessions with different chat clients (e.g., the chat client 170, and other chat clients). The conversation module 132 may use the chat server to establish chat sessions with different chat clients, and conduct conversations with different users via the chat sessions.

Based on the user inputs (e.g., utterances submitted by the user via a chat interface from voice or text), the conversation module 132 may generate content in response to the user inputs. For example, when the user 140 of the user device 110 submits an utterance “how do I file a dispute for a transaction,” the conversation module 132 may generate content (e.g., a response, etc.) related to instructions on how to file a dispute based on information related to the organization, and may transmit the generated content to the user via the chat interface as a response to the user inputs. In another example, when the user 140 of the user device 110 submits an utterance “I want to file a dispute for a transaction,” the conversation module 132 may generate content (e.g., one or more prompts, etc.) that asks the user for information required to process a dispute (e.g., a selection of a particular transaction that the user wants to dispute, a reason for the dispute, etc.), and may process the transaction (e.g., the dispute transaction) for the user based on the information.

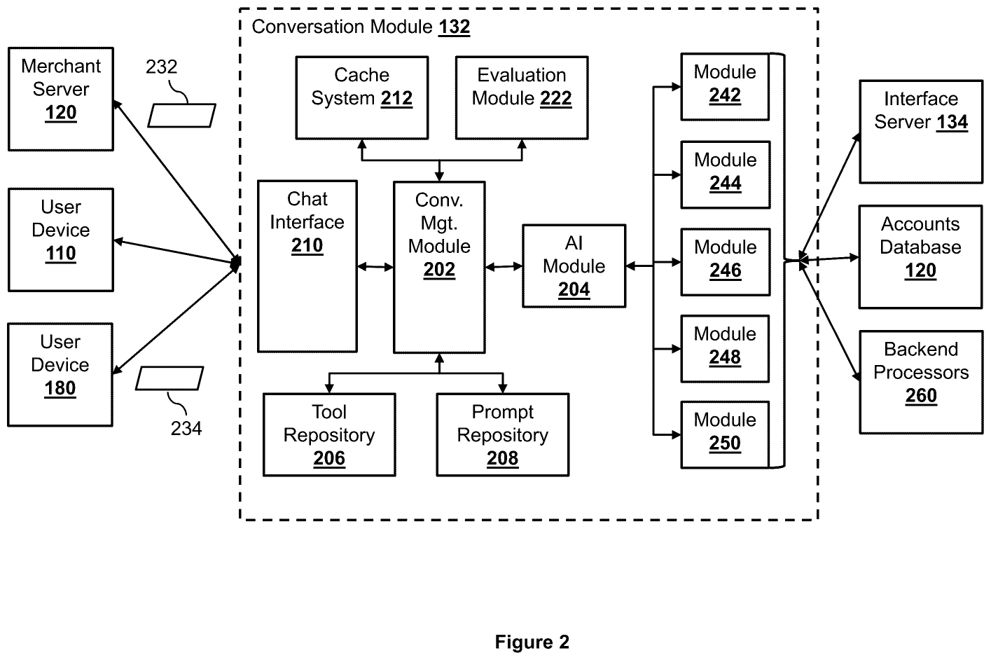

FIG. 2 illustrates a block diagram of the conversation module 132 according to an embodiment of the disclosure. The conversation module 132 includes a conversation management module 202, an artificial intelligence (AI) module 204, a tool repository 206, a prompt repository 208, a chat interface 210, a caching module 212, and an evaluation module 222. In some embodiments, the conversation module 132 may also include (or have access to) multiple backend modules 242, 244, 246, 248, and 250.

The chat interface 210 may be configured to establish and/or maintain communication sessions (also referred to as “chat sessions”) with various chat clients of different user devices, such as the chat client 170 of the user device 110, a chat client of the merchant server 120, a chat client of the user device 180, etc. For example, when the user 140 uses the chat client 170 to initiate a chat session with the conversation module 132, the chat interface 210 may establish a chat session with the chat client 170 using a particular protocol, which includes performing one or more handshakes with the chat client 170 to establish and assign a chat identifier to the chat session. The chat interface 210 may also maintain a communication with the chat client 170 until the chat session is terminated by either the conversation module 132 or the chat client 170. As such, the conversation module 132 may receive data (e.g., an utterance 232, etc.) from users of the service provider server 130 (e.g., the user 140) via the chat interface 210.

The tool repository 206 stores various computer software programs (also referred to as “tools”) that can be used by the conversation management module 202 to process an incoming utterance (e.g., the utterance 232, etc.). The prompt repository 208 stores specifications (also referred to as “prompt templates”) that can be used by the AI module 204 to generate follow-up questions to the users to obtain additional information for processing a transaction, and instructions (e.g., API calls) to the backend modules 242, 244, 246, 248, and 250 for performing one or more transactions for the users. In some embodiments, the AI module 204 may include (or have access to) one or more AI models for performing the functions as disclosed herein.

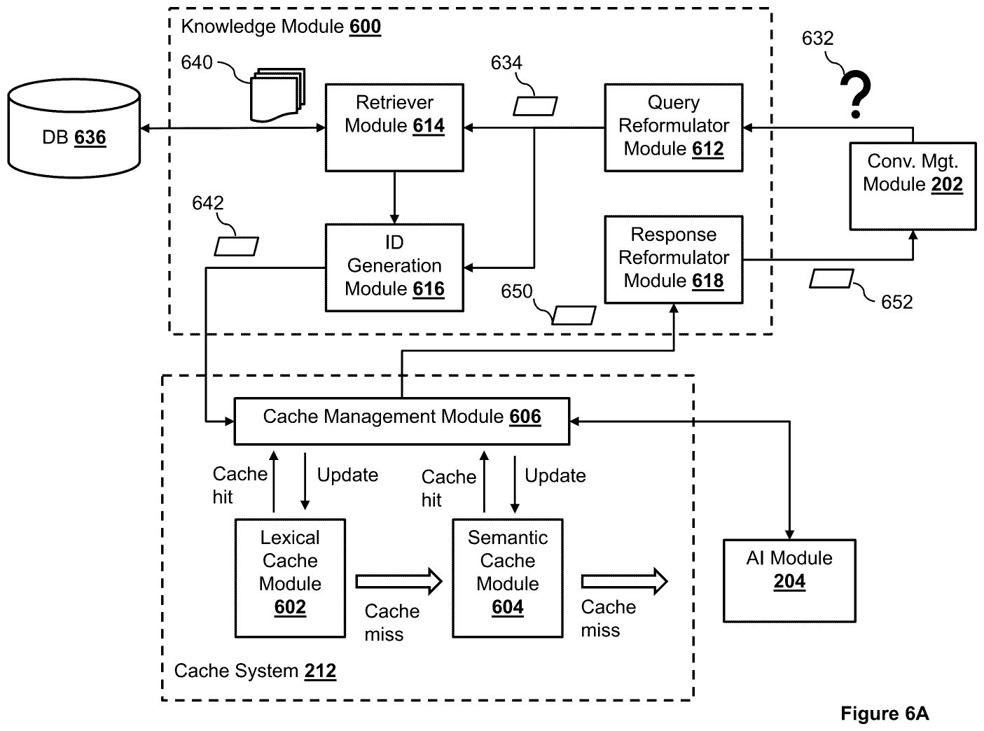

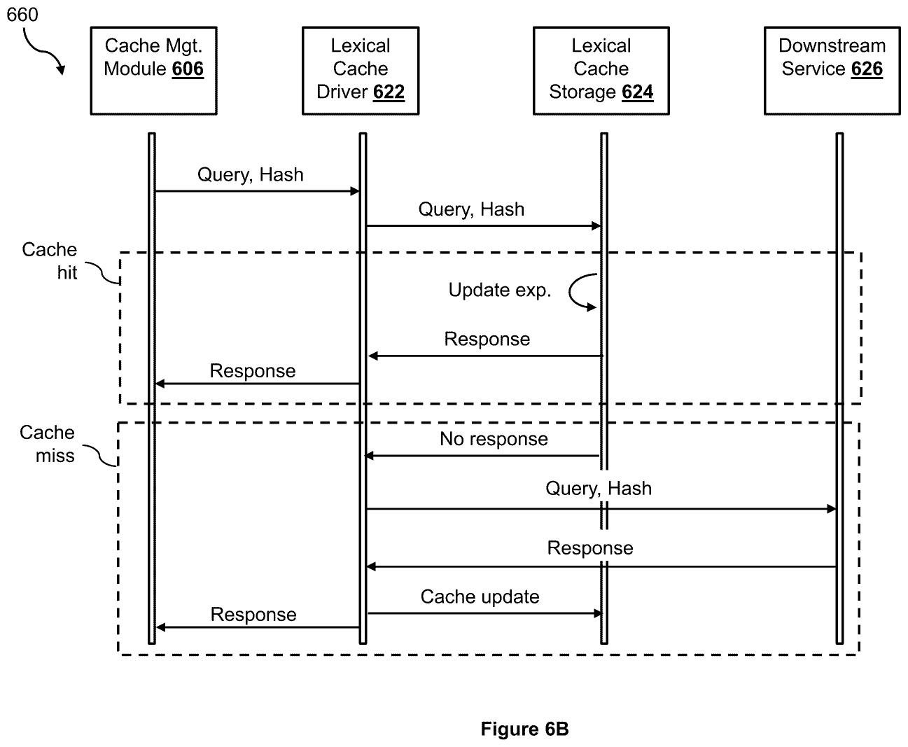

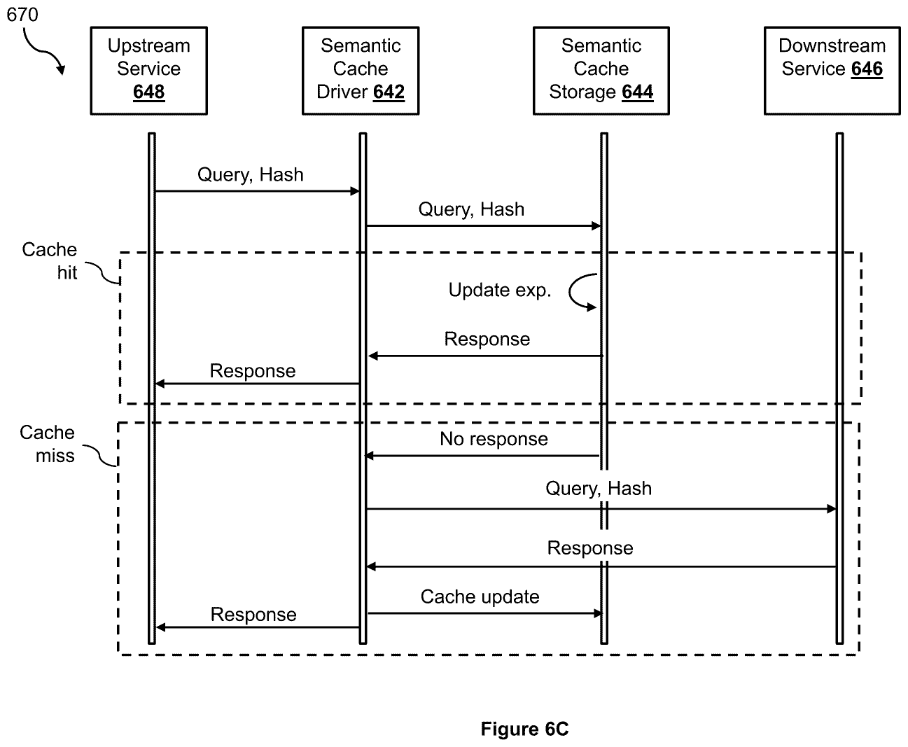

Each of the backend modules 242, 244, 246, 248, and 250 may be a computer module (e.g., a software module, etc.) that is configured to perform a transaction for the conversation module 132 via one or more application programming interfaces (APIs). For example, one or more of the backend modules 242, 244, 246, 248, and 250 may be configured to access data storages associated with the organization, such as the accounts database 136, the interface server 134, and other data storages, and retrieve content (e.g., webpages, articles, instruction manuals, etc.) that are related to a user query. Another one of the backend modules 242, 244, 246, 248, and 260 may correspond to the knowledge module as discussed herein, and may be configured to provide content to the users in response to various questions. For example, the knowledge module may use a retrieval module to retrieve information (e.g., documents, etc.) related to the utterance, and use the AI module 204 to generate a response to the utterance based on the retrieved information. The knowledge module will be discussed in more detail below by reference to FIG. 6A.

Other backend modules may be configured to process various types of transactions (e.g., a dispute transaction, a payment transaction, a data access transaction, an account management transaction, etc.) for the conversation module 132. In some embodiments, at least some of the backend modules 242, 244, 246, 248, and 250 may use services from one or more backend processors 260 for performing the transactions. The backend processors 260 may be associated with the service provider server 130 or a third-party entity (e.g., a financial institution, etc.).

The caching module 212 may cache frequently used content generated by the AI module 204 in a memory. If an utterance submitted by a user (e.g., the utterance 232) is matched with a cached content, the cached content can be retrieved and provided to the user without requiring the AI module 204 to process the utterance 232 in order to enhance the speed performance of the conversation module 132. In some embodiments, the evaluation module 222 may be configured to evaluation the performance of the conversation module 132, and may adjust various components of the conversation module 132 to continue to improve the performance of the conversation module 132.

As the conversation module 132 receives an utterance (e.g., the utterance 232) from a chat client (e.g., the chat client 170) via the chat interface 210, the conversation management module 202 may use one or more tools from the tool repository to perform an initial processing of the utterance. The AI module 204 may then communicate with one or more of the backend modules 242, 244, 246, 248, and 250 based on the processed utterance, and may generate a content 234 (e.g., a response to the utterance 232), which may be provided to the chat client via the chat interface 210.

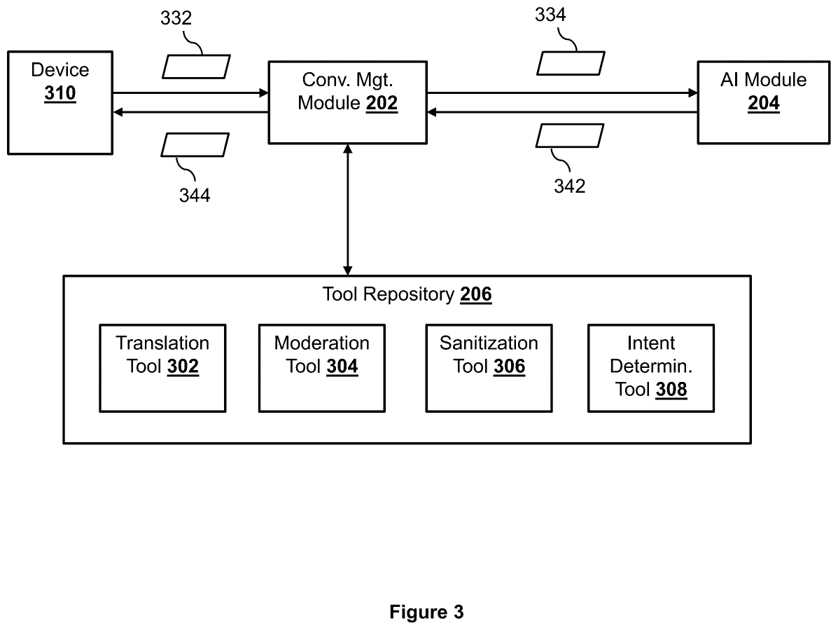

FIG. 3 illustrates an example flow for performing an initial processing of an utterance by the conversation management module 202 according to various embodiments of the disclosure. As shown, the tool repository 206 may include different tools, such as a translation tool 302, a moderation tool 304, a sanitization tool 306, and an intent determination tool 308. The translation tool 302 may be executed by the conversation management module 202 to detect languages or format used in the utterances and to perform transaction on the utterances. The moderation tool 304 may be executed by the conversation management module 202 to perform content moderation (e.g., removing offensive languages, detecting utterances that should not be processed by the AI module 204, etc.) on the utterances. The sanitization tool 306 may be executed by the conversation management module 202 to remove any words or phrases in the utterance that are not useful or needed for the AI module 204 to generate an answer (e.g., redundant words, words or phrases that are not related to an intent detected by the intent determination tool 308, etc.). The intent determination tool 308 may be executed by the conversation management module 202 to detect an intent associated with the utterance (e.g., what type of transactions does the user want to perform, etc.).

In some embodiments, the conversation management module 202 and/or the tool repository 206 may also store tool execution information that specifies various conditions for executing the different tools in the tool repository 206 and an order in which to execute the different tools. For example, the tool execution information may specify the execution of the translation tool 302 when the utterance 332 is detected to be in a language different from a particular language (e.g., English, etc.). The tool execution information may also specify the execution of the moderation tool 304, the sanitization tool 306, and the intent determination tool 308 for all utterances submitted by the users. The translation tool 302 and/or the intent determination tool 308 may also determine intent based on meanings associated with particular languages.

Thus, as the conversation management module 202 receives an utterance 332 from a device 310 via the chat interface 210, the conversation management module 132 may access the tool execution information, and may execute various tools in the tool repository 206 in a particular order according to the tool execution information. For example, the conversation management module 202 may execute the translation tool 302 to determine a language used in the utterance 332. If the utterance 332 is in a language different form a particular language compatible with the AI module 204 (e.g., English, etc.), the conversation management module 202 may be configured to execute the translation tool 302 on the utterance 332 to translate the utterance 332 from the original language to the particular language. After translating the utterance 332, the conversation management module 202 may execute the moderation tool 304 and the intent determination tool 308 on the utterance 332. The processed utterance 334 may then be passed to the AI module 204 for further processing (e.g., generating content for the user, processing a transaction, etc.).

Based on the processed utterance 334, the AI module 204 may generate content (e.g., a response 342) as a response for the user. In some embodiments, the conversation management module 202 may also perform certain processes to the response 342 before providing a processed response 344 to the user via the chat interface based on the tool execution information. For example, if the language used in the original utterance 332 is different from the particular language compatible with the AI module 204, the conversation management module 202 may use the transaction tool 302 on the response 342 to translate the response from the particular language to the original language used by the user of the device 310. The conversation management module 202 may then transmit a processed response 344 to the device 310 via the chat interface 210.

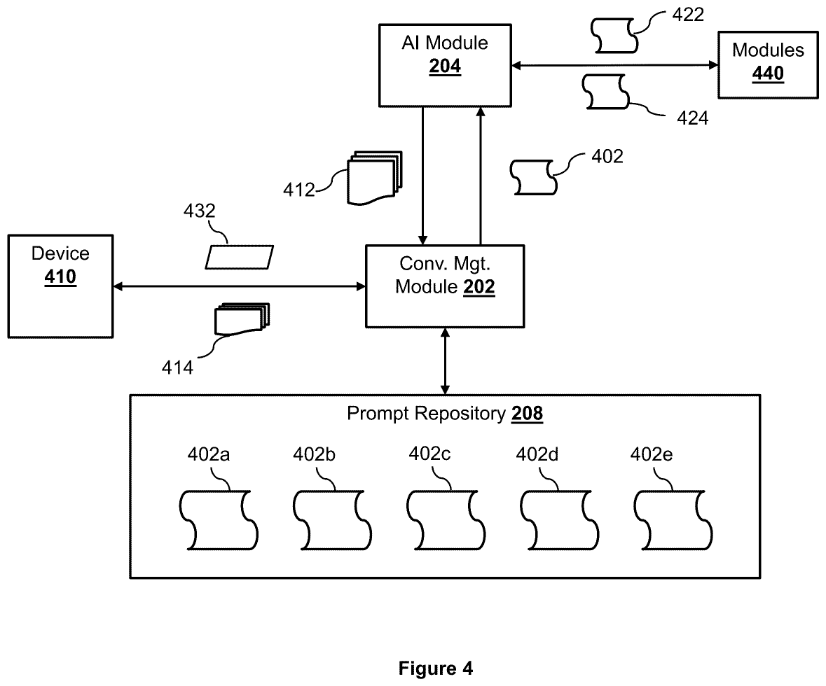

FIG. 4 illustrates an example flow for the AI module 204 to generate content according to various embodiments of the disclosure. As discussed herein, the AI module 204 is configured to interact with various backend modules 440 (which may correspond to the backend modules 242, 244, 246, 248, and 250) for performing different transactions for the user. However, different backend modules may use different interfaces (e.g., different APIs) for communicating with the AI module 204. Furthermore, different backend modules may also require different information for processing the corresponding transaction. For example, a backend module configured to manage user accounts may require an account identifier and credential for accessing a user account, whereas a backend module configured to perform a dispute transaction may require a transaction identifier associated with a transaction to be disputed and a reason for the dispute. Thus, it can be a challenge for the AI module 204 to learn all of the different interfaces for communicating with the different backend modules and the different information required by the different backend modules for processing the corresponding transactions, especially if the backend modules can be updated over time.

As such, the conversation management module 202 may use the specifications (e.g., specifications 402a, 402b, 402c, 402d, and 402e) stored in the prompt repository 208 to aid the AI module 204 in generating instructions (e.g., API calls) for the backend modules and obtaining the required information for processing the transactions. The specifications 402a, 402b, 402c, 402d, and 402e may be generated in a particular format that is interpretable by the AI module 204, such as a text format, an XML format, a JSON format, etc. In some embodiments, a specification may be generated for each backend module (e.g., generated by a human or another computer module based on analyzing requirements associated with the corresponding backend modules, etc.). For example, the specification 402a may be generated for one of the backend modules 440, the specification 402b may be generated for another one of the backend modules 440, the specification 402c may be generated for another one of the backend modules 440, the specification 402d may be generated for another one of the backend module 440, and the specification 402c may be generated for yet another one of the backend module 440.

Each specification may include information about how to communicate with the corresponding backend module. For example, each specification may include a description of the backend module (e.g., the transaction type that the corresponding backend module is capable of performing), one or more API calls usable for communicating with the corresponding backend module, the functionality (e.g., an expected result) for each API call, a list of parameters (e.g., required parameters, optional parameters, etc.) for each API call, and other information. In some embodiments, each specification includes information that is usable by the AI model to generate (1) one or more questions for prompting the user for any missing information that is required for performing the transaction and (2) instructions (e.g., one or more API calls) for the backend module to perform the transaction.

For example, when one of the backend modules 440 is configured to perform a payment transaction, the specification 402a corresponding to the backend module may specify one or more API calls for instructing the backend module to process a specific payment transaction. The specification 402a may also specify various input parameters for the API calls, where the input parameters correspond to various data types or content that are required by the backend module to process the payment transaction, such as information associated with a funding source, an identity of a recipient, etc.

In another example, when another one of the backend modules 440 is configured to perform a dispute transaction, the specification 402b corresponding to the backend module 244 may specify one or more API calls for instructing the backend module to process a specific dispute transaction. The specification 402b may also specify various input parameters for the API calls, such as a transaction identifier of a particular transaction, a reason for the dispute, etc.

In yet another example, when another one of the backend modules 440 is configured to retrieve knowledge about a specific topic for the AI model 204, the specification 402c may specify one or more API calls for instructing the backend module to retrieve data associated with the specific topic. The specification may also specify various input parameters for the API calls, such as a topic category, the user-submitted utterance, etc.

In some embodiments, as the conversation management module 202 receives an utterance 432 from a device 410, the conversation management module 202 may determine or predict an intent of a user of the device 410 based on the utterance 432. For example, the conversation management module 202 may use the intent determination tool 308 to determine an intent of the user. The intent may specify a question or a particular transaction that the user would like to perform. Based on the intent, the conversation management module 202 may determine one of the backend modules 440 that is capable of processing the user's request, and may select a corresponding specification 402 (which may be any one of the specifications 402a, 402b, 402c, 402d, 402c stored in the prompt repository 208, etc.) from the prompt repository 208 for that backend module 440. The conversation management module 202 may then pass the specification 402 along with the utterance 432 to the AI module 204. For example, the conversation management module 202 may generate a prompt for the AI module 204 based on the specification 402 and the utterance 432 and transmit the prompt to the AI module 204.

Based on the prompt generated by the conversation management module 202, the AI module 204 may generate different content to process the user's request. For example, if the user asks for certain information about the organization (e.g., “how to display a QR code on my phone?”), the AI module 204 may generate instructions 422 (e.g., an API call, etc.) for one or more of the backend modules 440 (which in this example, corresponds to the backend module 250) for retrieving information related to displaying QR code. In some embodiments, the instructions 422 may include a function name corresponding to a function (e.g., the API call, etc.) and input parameters associated with the function (e.g., retrieveInfo (“display QR”), etc.). On the other hand, if the user requests to perform a transaction (e.g., “I would like to file a dispute”), the AI module 204 may determine whether all of the information required by one of the backend modules 440 (which in this example, corresponds to the backend module 244) to perform the dispute transaction has been obtained. In some embodiments, the AI module 204 may refer to the specification 402 to determine all of the data fields required by one of the backend modules 440 (e.g., user account identifier, transaction identifier, reason for the dispute, etc.). The AI module 204 may attempt to fill the data fields with data available to the AI module 204 (e.g., data that can be extracted from the utterance 432 or the chat session, etc.). The AI module 204 may then determine if any of the data fields has missing data, and if so, the AI module 204 may generate questions 414 for prompting the user of the device 410 for the missing data.

The AI module 204 may continue to extract data from one or more utterances submitted by the user of the device 410, and use the extracted data to fill in the data fields in the specification. In some cases, the AI module 204 may be required to transmit multiple questions to the user to obtain all of the missing data, possibly because the AI module 204 cannot ask for all of the missing data in a single question, or the user does not provide the correct type of data immediately following the question. After obtaining all of the required data, the AI module 204 may generate instructions 422 (e.g., one or more API calls with the input parameters, etc.) for the backend module 440.

The backend module 440 may process a transaction based on the instructions 422 provided by the AI module 204. After processing the transaction, the backend module 440 may return an output 424. If the backend module 440 corresponds to the backend module 250 and is configured to retrieve information for the AI module 204, the output 424 may include all of the information that the backend module 440 has retrieved based on a specific topic. If the backend module 440 is configured to process a transaction, the output 424 may indicate whether the transaction has been processed successfully.

The AI module 204 may generate content 412 (e.g., a response to the user's utterance 432) based on the output 424. In some embodiments, the conversation management module 202 may provide the content 412 to the device 410 via the chat interface 210.

In some embodiments, there is a one-to-one correlation between the number of specifications and the number of backend modules, such that each specification corresponds to a distinct backend module. By using the conversation management module 202 to dynamically select different specifications from the prompt repository 208 for the AI module 204, the conversation module 132 becomes more flexible and scalable. For example, a new backend module can be easily integrated within the conversation module 132 by simply generating a new specification for the new backend module, and add the new specification to the prompt repository 208. The conversation management module 202 may be configured to recognize a new transaction type corresponding to the new backend module such that the conversation management module 202 may select the new specification for the AI module when a transaction of the new transaction type is requested by a user during a chat session. In another example, when any one of the backend modules 242, 244, 246, 248, and 250 is modified (e.g., requiring different input parameters, different API call formats, etc.), the corresponding specification stored in the prompt repository 208 may be amended based on the modifications. As such, no changes (e.g., modification to the parameters of the AI model 204) or re-training to the AI model 204 is necessary to accommodate any expansion and/or modification to the backend modules 242, 244, 246, 248, and 250 of the conversation module 132.

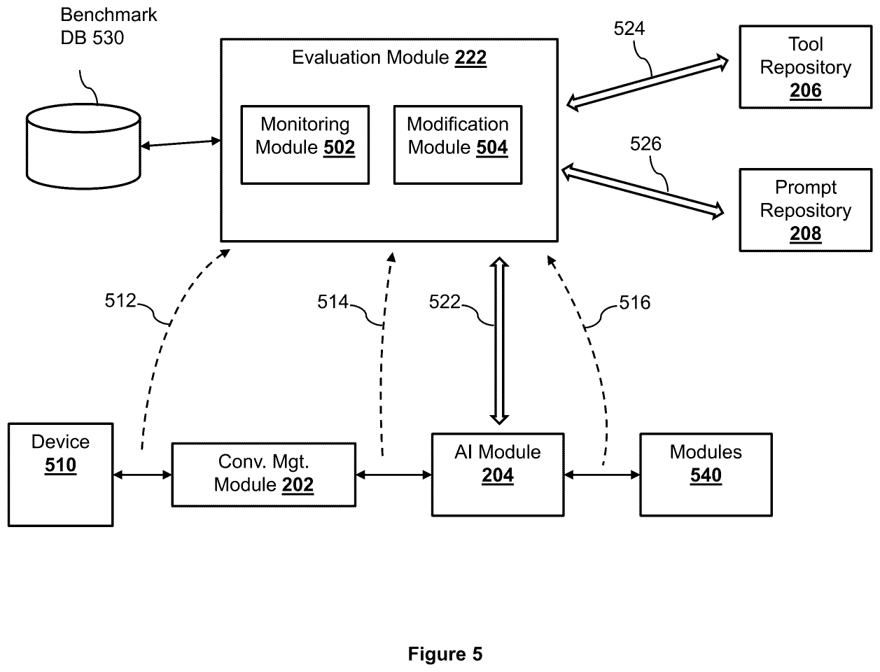

FIG. 5 illustrates a block diagram of the evaluation module 222 according to various embodiments of the disclosure. As shown, the evaluation module 222 includes a monitoring module 502 and a modification module 504. In some embodiments, the monitoring module 502 may be configured to monitor activities related to the conversation module 132. For example, after the conversation module 132 establishes a chat session with a device 510, the evaluation module 222 may use the monitoring module 502 to begin monitoring the interactions between the device 510 and the conversation module 132 during the chat session and the interactions among different components in the conversation module 132 for the chat session. The interactions may include utterances that the device 510 transmits to the conversation module 132 during the chat session and content that the conversation module 132 transmits to the device 510 in response to the utterances. The interactions may also include communications that the conversation management module 202 provides to the AI module 204, such as processed utterances, specifications that the conversation management module 202 retrieves from the prompt repository 208, etc., and content generated by the AI module 204 and provided to the conversation management module 202. The interactions may also include instructions generated by the AI module 204 and provided to the backend modules 540 (which may correspond to the backend modules 242, 244, 246, 248, and 250), and outputs generated by the backend modules 540 and provided to the AI module 204.

In some embodiments, the evaluation module 222 may use a set of metrics to evaluate the performance of the conversation module 132 and also the performance of different components of the conversation module 132 based on the monitored interactions. The set of metrics may correspond to different characteristics of the interactions monitored by the evaluation module 222. For example, the set of metrics may include one or more metrics that measure the quality of the processed utterance provided by the conversation management module 202 to the AI module 204, one or more metrics that measure the quality of content generated by the AI module 204 and provided to the device 510 in response to one or more user-generated utterances, one or more metrics that measure the quality of the instructions generated by the AI model 204 for the backend modules 540, which may correspond to the backend modules 242, 244, 246, 248, and 250 in FIG. 2 for processing transactions, and one or more metrics that measure the quality of the overall conversation between the conversation module 132 and the device 510.

In order to evaluate the content generated by the AI module 204, the evaluation module 222 may generate (or otherwise obtain) benchmark contents associated with various topics, such that the quality of the contents generated by the AI module 204 can be determined based on comparing the generated content against a corresponding benchmark content. As such, the evaluation module 222 may be communicatively coupled with a benchmark database 530 that stores the benchmark content corresponding to various topics. In some embodiments, the benchmark database 530 may include benchmark answers that are related to potential questions (or previously asked questions) that can be transmitted by users (e.g., the user of the device 510, etc.). For example, the benchmark answers may provide information related to various topics associated with the organization, such as “how to file a dispute,” “how to track a package,” “how does the ‘pay-it-later’ program work,” etc. The benchmark answers may be generated by humans or pre-generated by the AI module 204 (and optionally reviewed and/or edited by humans). The benchmark database 530 may also include benchmark questions that are related to various data types or content for which the AI module 204 may prompt the users in order to process requested transactions based on the various specifications, such as specifications 402a, 402b, 402c, 402d, and 402c.

When the monitoring module 502 accesses a content (which can include an answer to the user-generated utterance, or a question for prompting the user for specific types of data) generated by the AI module 204 and provided to the device 510, the evaluation module 222 may determine if a benchmark content stored in the benchmark database 530 corresponds to the content generated by the AI module 204. If a corresponding benchmark content is stored in the benchmark database 530, the evaluation module 222 may compare the content generated by the AI module 204 against the corresponding benchmark content.

In some embodiments, the evaluation module 222 may evaluate the semantic quality of the content and the syntactic quality of the content. For example, the evaluation module 222 may generate vector representations that represent the meanings of the benchmark content, and may also generate vector representations that represent the meanings of the content generated by the AI module 204. The evaluation module 222 may then compare the vector representations of the benchmark content and the vector representations of the content generated by the AI module 204. The evaluation module 222 may determine the semantic quality of the content generated by the AI module 204 based on how similar the vector representations are between the benchmark content and the content generated by the AI module 204 (e.g., a distance between the vector representations of the benchmark content and the vector representations of the content generated by the AI module 204 in a multi-dimensional plane). The more similar (e.g., the shorter the distance) between the vector representations, the higher the semantic quality is determined for the content.

The evaluation module 222 may evaluate different content generated by the AI module 204 for different users. If it is determined that the semantic quality of the content generated by the AI module 204 is below a threshold quality, the evaluation module 222 may use the modification module 504 to adjust the AI module 204 (e.g., adjusting one or more parameters of the AI model of the AI module 204) and/or modifying the specification(s) from the prompt repository 208 that were used by the AI module 203 to generate the content.

The evaluation module 222 may also analyze the content generated by the AI module 204 to derive a syntactic quality for the content. For example, the evaluation module 222 may determine a tone, a choice of words/phrases, a clarity, a conciseness, and/or other characteristics of the content, and may assess whether one or more of these characteristics of the content is appropriate for the user of the device 510. In some embodiments, the evaluation module 222 may determine the syntactic quality of the content further based on the user of the device 510. For example, if the user is relatively young (e.g., below an age threshold), the tone and the choice of words/phrases can lean toward more casual, and the content can be more concise. On the other hand, if the user is relatively mature (e.g., above the age threshold), the tone and the choice of words/phrases can lean toward more formal, and the content needs to be clearer and more elaborate. Customary meanings of words in different languages may also be considered in predicting an intent or determining an inquiry.

If it is determined that the syntactic quality of the contents generated by the AI module 204 is below a threshold, the evaluation module 222 may use the modification module 504 to modify the AI module 204 (e.g., adjusting one or more parameters of the AI model of the AI module 204, etc.).

In some embodiments, the evaluation module 222 may also evaluate the processing of the utterances by the conversation management module 202. As discussed herein, the conversation management module 202 may process utterances transmitted by the users before providing the processed utterances to the AI module 204. The conversation management module 202 may also process content generated by the AI module 204 before providing the processed content to the devices (e.g., the device 510). By comparing the pre-processed utterances/contents and the post-processed utterances/contents, the evaluation module 222 may determine a quality of the processing on the utterances/contents. If it is determined that the quality of the processing on the utterances and/or the contents is below a threshold, the evaluation module 222 may use the modification module 504 to modify the tools in the tool repository 206, such as adjusting the programming code of one or more tools in the tool repository 206.

In addition to evaluating individual data generated by different components, such as the conversation management module 202, the AI module 204, and the backend modules 540, the evaluation module 222 may also evaluate the quality of the overall conversation between the user of the device 510 and the conversation module 132. A conversation may include the interactions between the device 510 and the conversation module 132 during the same chat session. In some embodiments, the evaluation module 222 may derive different attributes associated with the conversation between the user of the device 510 and the conversation module 132 based on the interactions between the device 510 and the conversation module 132 monitored by the monitoring module 502. The attributes may include a number of dialogue turns between the device 510 and the conversation module 132. Each conversation between the conversation module 132 and a user (e.g., the conversation between the user of the device 510 the conversation module 132) may include multiple dialogue turns, where each dialogue turn includes a pair of exchanges between the user and the conversation module 132 (e.g., one or more utterances from the user and one or more responses from the conversation module 132). In some embodiments, the evaluation module 222 may evaluate the quality of the overall conversation based on the number of dialogue turns required to complete a transaction (e.g., when the user has obtained the information being requested or when a transaction has been successfully processed by the backend modules, etc.). The number of dialogue turns may indicate an efficiency of the AI module 204 in communicating the necessary information (or questions) to the user for processing a user request.

In some embodiments, the evaluation module 222 may determine benchmark dialogue turns for each type of user request (e.g., an information request, a request for processing a payment transaction, a request for processing a dispute transaction, a request for editing account information, etc.). For each request made by a user of the device 510, the evaluation module 222 may determine a number of dialogue turns conducted between the device 510 and the conversation module 132 for completing the transaction. The evaluation module 222 may compare the actual number of dialogue turns conducted between the device 510 and the conversation module 132 against a corresponding benchmark. If the number of dialogue turns exceeds the benchmark by a threshold (e.g., a 50%, 100%, etc.), the evaluation module 222 may determine that the communication between the AI module 204 and the user of the device 510 is inefficient. The evaluation module 222 may investigate further, such as by assessing the different metrics determined for the different components of the conversation module 132. Based on the different metrics, the modification module 504 may determine one or more causes for the inefficiencies, and may adjust one or more of the components of the conversation module 132 (e.g., one or more tools in the tool repository 206, one or more specifications in the prompt repository 208, one or more parameters of the AI module 204, etc.).

The evaluation module 222 may evaluate different conversations with different users to continuously monitor the quality of the different components of the conversation module 132, and may perform actions (e.g., modifying different components of the conversation module 132) to improve the performance of the conversation module 132 without requiring interference from human computer program developers.

FIG. 6A illustrates a block diagram of a knowledge module 600 according to various embodiments of the disclosure. The knowledge module 600 includes a query reformulator module 612, a retriever module 614, a response reformulator module 618, and an identifier (ID) generation module 616. As shown in FIG. 6A, the knowledge module 600 is communicatively coupled with a data storage 636 and the cache system 212. The data storage 636 stores information (e.g., articles, webpage content, instruction manuals, videos, podcasts, audio, etc.) associated with the service provider server 130. As such, the information stored in the data storage 636 may be relevant to answering questions submitted by users of the service provider server 130. In some embodiments, when the knowledge module 600 receives a user utterance 632 in a form of a query (e.g., a question or a statement, such as “Change my password”) from the conversation management module 202, the knowledge module 600 retrieves information (e.g., one or more documents, etc.) that is relevant to the user utterance 632 from the data storage 636. For example, if the user utterance 632 includes a question related to how to change a password, the knowledge module 600 may retrieve articles, user manuals, or other information that is related to instructions for changing a password on a user interface (e.g., a website, a mobile application, etc.) associated with the service provider server 130.

However, as discussed herein, the user utterance 632 received from the user device may be out of context and/or may not include sufficient information for the knowledge module 600 to retrieve the relevant information from the data storage 636, in which case, the knowledge module 600 may use the query reformulator module 612 to reformulate the utterance 632 based on a context associated with the utterance 632. For example, a user may initially submit an utterance “how do I change password,” and then subsequently asks “how to do it on an iPhone?” Based on the utterance “how to do it on an iPhone,” the knowledge module 600 may not have sufficient information to retrieve the documents that would be usable by the AI module 204 to answer the user's first utterance. As such, the query reformulator module 612 may analyze one or more other utterances that have been exchanged between a user device of the user and the conversation module 132, and derive a context based on the utterances. The analyzed other utterances may only be for a certain time period of the first utterance, such as 10 seconds before or after. The time period may also be limited to the current chat session in other embodiments. The query reformulator module 612 may then modify the user utterance 632 based on the derived context (e.g., incorporating the context into the user query, etc.) to generate a reformulated query 634. In the example illustrated above, the query reformulator module 612 may determine that the utterance is related to changing a password based on analyzing the previous utterance submitted by the user. The query reformulator module may then reformulate (e.g., modify) the utterance from “how to do it on an iPhone” to a reformulated query “how do I change my password on an iPhone.”

It has been contemplated that the utterance 632 submitted by the user may include personal information that is unique to the user, and that may not be helpful (or may even be harmful) for the knowledge module 600 in retrieving the relevant information for the AI module 204. For example, a user may submit an utterance “how do I dispute my recent transaction in the amount of $20?” The information related to the exact amount of the transaction may be relevant to the user, but may neither be relevant nor useful in retrieving documents that can be used to provide an answer to the utterance. This information may even hinder the effort of the retrieval module in retrieving relevant documents for the utterance, as the information related to disputing a transaction that is stored in the data storage would likely not include any specific amount. As such, the query reformulator module 612 may be configured to remove any personal or other type of information that is not helpful in providing an accurate response to the utterance before providing the reformulated query 634 to the retrieval module 614 for retrieving the relevant information 640.

In some embodiments, the knowledge module 600 stores the information removed from the utterance 632 in a temporary storage when the utterance 632 is being processed, such that the removed information may be incorporated back into the response (e.g., a response 650) before providing a reformulated response 652 to the user. For example, after the knowledge module 600 obtains the response 650 either from the cache system 212 or the AI module 204, the response reformulator module 618 may incorporate the removed information stored in the temporary storage back into the response 650. The reformulated response 652 may include “You can follow the following steps to dispute your recent transaction in the amount of $20 . . . ” By incorporating the removed information back into the response 650, the response 652 may appear more personalized for the user.

After the reformulated query 634 is generated, the retriever module 614 may use the reformulated query 634 to retrieve relevant documents 640 that are relevant to the reformulated query 634 from the data storage 636. The relevant documents 640 may include information that can be used by the AI module 204 for generating content (e.g., a response) for responding to the utterance 632. As such, the knowledge module 600 may use the AI module 204 to generate content for the utterance 632 based on the relevant documents 640. For example, the knowledge module 600 may generate a prompt for the AI module 204 that includes the utterance 632 and/or the reformulated query 634, and the relevant documents 640. Based on the prompt, the AI module 204 may generate a response to the utterance 632 using information extracted from the relevant documents 640.

As discussed herein, the AI module 204 typically consumes a substantial amount of computer processing resources and time to dynamically generate content (e.g., responses to user questions, prompts for users, etc.). In order to further enhance the speed performance of the knowledge module 600, and thus efficiency and accuracy, in processing user requests, the knowledge module 600 may use the cache system 212 to store frequently used/requested content. The cache system 212 may store frequently used/requested content in one or more cache memories, which can be implemented within a hardware memory unit, such as a SRAM, a DRAM, etc.

In some embodiments, before using the AI module 204 to generate content for the reformulated utterance 634, the knowledge module 600 may first determine whether content that is responsive to the reformulated query 634 is stored in the cache system 212. If content that is responsive to the reformulated query 634 is stored in the cache system 212 (e.g., resulting in a cache hit in the cache system 212), the knowledge module 600 may use the content (e.g., a response) retrieved from the cache system 212 as a response to the utterance 632, and provide the stored response to the user device via the conversation management module 202 without using the AI module 204 to regenerate content for the utterance 632, thereby reducing the amount of time (and the required computer processing resources) to respond to the user's utterance 632. On the other hand, when it is determined that no content that is responsive to the reformulated utterance 632 is stored in the cache system 212 (e.g., resulting in a cache miss in the cache system 212), the knowledge module 600 may instruct the AI module 204 to generate a response for the utterance 632.

As shown in FIG. 6A, the cache system 212 includes a cache management module 606, a lexical cache module 602, and a semantic cache module 604. As discussed herein, the cache system 212 may be implemented as a multi-tiered cache system that includes multiple cache modules that work together in a tiered (e.g., hierarchical) structure. In this example, the cache system 212 has two tiers, including a first tier (e.g., the lexical cache module 602) and a second tier (e.g., the semantic cache module 604). While only two tiers of cache modules are included in the cache system 212 in this example, it has been contemplated that the cache system 212 may include more than two tiers (e.g., three tiers, five tiers, etc.).

Each of the cache modules (e.g., the lexical cache module 602, the semantic cache module 604, etc.) may include, or be associated with, a distinct cache memory (also referred to as a “cache storage”), and use a different cache querying structure for caching/querying data. In this example, the lexical cache module 602 may use a text-based cache querying structure for caching/querying data. For example, the lexical cache module 602 may store the actual text in an utterance (e.g., the entire utterance, keywords extracted from the utterance, etc.) as the key in a cache record, and store the content generated by the AI module 204 for the utterance as the corresponding value in the cache record. The lexical cache module 602 may store the cache records in a cache storage (e.g., a cache memory) associated with the lexical cache module 602. When a new utterance (e.g., the reformulated query 634) is received, the lexical cache module 602 may determine whether the reformulated query 634 matches any of the keys in the cache storage of the lexical cache module 602. If a match (e.g., an exact match, a fuzzy match, etc.) of the reformulated utterance 634 is found in the cache storage, the lexical cache module 602 may determine that a cache hit has occurred, and return the value (e.g., the content generated by the AI module 204 for the utterance in the cache record) corresponding to the matched key from the cache storage of the lexical cache module 602 as a response 650 to the user utterance 632 without requiring the AI module 204 to process the reformulated utterance 634.

While querying the cached contents using the lexical cache module 602 can be fast, it may produce a high level of cache misses (e.g., exceeding a threshold) because utterances submitted by the users can be worded very differently, even if they carry substantially the same meaning. For example, while these two utterances “how to reset my password” and “how to change my account credentials” include very different words, they have a similar meaning, and a similar or same response should be provided for responding to these two utterances. However, since the two utterances use different words to describe the same question, they will not produce a match in the lexical cache module 602 even though one of the utterances and the corresponding response is stored in the cache storage of the lexical cache module 602.

As such, the cache management module 606 may provide the reformulated utterance 634 to the lexical cache module 602 first. When the lexical cache module 602 determines a cache miss, the cache management module 606 may provide the reformulated utterance 634 to a cache module in a subsequent tier (e.g., the semantic cache module 604). The semantic cache module 604 may use a different cache querying structure for caching/querying data than the lexical cache module 602. Instead of using the words in the utterance to determine whether a match occurs, the semantic cache module 604 derives a meaning of the words in the utterance, and uses the meaning to determine a match. For example, the semantic cache module 604 may store embeddings derived from previously submitted utterances as keys in a cache storage of the semantic cache module 604. Each embedding may be implemented as a vector in a multi-dimensional space, where each dimension represents a distinct aspect. In some embodiments, a machine learning model (e.g., the AI module 204) is used by the semantic cache module 604 to generate the embeddings for each utterance. The embeddings derived for each utterance represent the semantic meaning associated with the utterance that is not bound by the actual words used in the utterance. As such, embeddings that are generated from two different utterances that include different wordings, but carry similar meanings, may be close with each other (e.g., when a Euclidean distance between the embeddings is within a threshold distance) within the multi-dimensional space. Similar to the lexical cache module 602, the responses that were generated by the AI module 204 are stored as corresponding values in the cache storage of the semantic cache module 604.

When the new utterance (e.g., the reformulated utterance 634) results in a cache miss in the lexical cache module 602, the cache management module 606 may provide the reformulated utterance 634 to the semantic cache module 604. The semantic cache module 604 may generate embeddings based on analyzing the words in the reformulated utterance 634, and determine whether the reformulated utterance 634 match any of the keys in the cache storage of the semantic cache module 604 based on the embeddings. For example, the semantic cache module 604 may determine that the reformulated utterance 634 matches a key in the cache storage when the embeddings of the reformulated utterance 634 are within a threshold distance from the key in the cache storage within the multi-dimensional space. Since the embeddings represent the semantic meaning of the utterance independent of the words used in the reformulated utterance 634, the reformulated utterance 634 may be matched with a previously submitted utterance as long as their meanings are similar, even though different words were used in the previously submitted utterance.

If a match of the reformulated utterance 634 is found in the cache storage, the semantic cache module 604 may determine that a cache hit has occurred, and return the value (e.g., the response) corresponding to the matched key from the cache storage of the second cache module as the response 650 to the user utterance without requiring the AI model to process the utterance. Since the semantic cache module 604 attempts to match the user-submitted utterances to cached contents based on the actual meanings (instead of the words) of the utterances, the semantic cache module 604 would produce cache hits for utterances that resulted in cache misses in the lexical cache module 602. In some embodiments, when a cache hit occurs in the semantic cache module 604, the cache management module 606 updates the lexical cache module 602 with the content retrieved from the semantic cache module 604. For example, the cache management module 606 may add a new cache record to the cache storage of the lexical cache module 602 using the reformulated utterance 634 (or keywords extracted from the reformulated utterance 634) as the key and the content retrieved from the semantic cache module 604 as the value in the cache record.

If the semantic cache module 604 determines a cache miss for the reformulated utterance 634 (e.g., when the embeddings generated based on the reformulated utterance 634 do not match with any of the keys in the cache storage of the semantic cache module 604), the cache management module 606 may continue to use additional cache module(s) (if available) in the lower tiers for retrieving cached responses for the reformulated utterance 634. If no other cache module is available, or if all of the cache modules return with cache misses, the cache management module 606 may provide the reformulated utterance 634 and the relevant documents 640 to the AI module 204 for generating the response 650. The cache management module 606 may return the response 650 to the knowledge module 600. As discussed above, the knowledge module 600 may use the response reformulator module 618 to reformulate the response 650 (e.g., incorporating personal information back into the response 650), and provide the reformulated response 652 to the conversation management module 202.

When the response 650 is obtained from the AI module 204, the cache management module 606 may update both of the lexical cache module 602 and the semantic cache module 604. For example, the cache management module 606 may add a new cache record to the cache storage of the lexical cache module 602 using the reformulated utterance 634 (or keywords extracted from the reformulated utterance 634) as the key and the content generated by the AI module 204 as the value in the cache record. The cache management module 606 may also add a new cache record to the cache storage of the semantic cache module 604 using the embeddings generated based on the reformulated utterance 634 as the key and the content generated by the AI module 204 as the value in the cache record.

The generation of embeddings can consume a substantial amount of computer processing resources. As such, the semantic cache module 604 can consume a larger amount of computer processing resources and time to perform cache retrieval than the lexical cache module 602. However, using the embeddings that represent the meaning of the utterance/content provides a higher accuracy performance of identifying matches between utterances and cached contents. As such, the arrangement of having the two-tiered structure in the cache system 212 provides an enhanced performance for the conversation module 132 because the semantic cache module 604 (which requires substantially more computer processing resources and time than the lexical cache 602) is used only after the lexical cache module 602 produces a cache miss for an utterance. As such, at least a portion of cache hits can be served by only using the lexical cache module 602, which is faster and consumes less computer processing resources than the semantic cache 604. Furthermore, the accuracy performance of the cache system 212 is not sacrificed since any false cache misses from the lexical cache module 602 will be caught by subsequently using the semantic cache module 604.

Since the cache storages of the different cache modules 602 and 604 are inherently limited in capacity, the cache management module 606 may use a time-to-live (TTL) methodology to ensure that responses that are not used/requested frequently are removed from the cache storage(s) such that newly generated responses that are used/requested frequently can be adequately cached. In some embodiments, every cache record stored in a cache storage is associated with a TTL that indicates an expiration time of the cache record. The cache management module 606 (or each of the cache modules 602 and 604, etc.) may monitor the TTL of the cache records in the cache storages, and may automatically remove (e.g., delete) the cache records that have expired based on their corresponding TTL. In some embodiments, when a response is added to a cache storage (e.g., as a new cache record, etc.), the response (or the new cache record) is assigned a predetermined maximum TTL (e.g., 24 hours, one week, etc.). The maximum TTL may vary based on the type of response, e.g., responses that are likely not to vary (even if seldom used) may have longer TTLs than responses that change frequently. At the end of the TTL period, the cache record would be removed from the cache storage. However, if the cache record is accessed based on a cache hit (e.g., the response in the cache record is retrieved as a cache hit for an utterance, etc.), the cache management module 606 or the corresponding cache module may update the TTL of the cache record (e.g., extend the TTL to the predetermined maximum TTL, etc.). This way, cache records that are used/requested frequently would remain in the cache storage(s) while cache records that are not frequently used/requested would be removed to provide memory space for new cache records.

Since content (e.g., responses) that is stored in the cache storages of the cache modules 602 and 604 was generated by the AI module 204 based on information retrieved from the data storage 636 (and/or other various sources associated with the service provider server 130), it has been contemplated that the underlying information from which the cached content was generated may change (e.g., updated) over time. As such, some of the cached content may become inaccurate (e.g., out-of-date). In some embodiments, the cache system 212 determines whether a cached content stored in a cache record is out-of-date based on a document identifier that is also stored in the cache record. The document identifier may be implemented as a hash value, that is generated by processing the document(s) used for generating a particular content using a hash algorithm. In some embodiments, after the retriever module 614 retrieves the relevant documents (e.g., the documents 640) based on the reformulated utterance, the knowledge module 600 may use the ID generation module 616 to generate a document identifier based on the documents 640. The document identifier, along with the reformulated utterance 634 and the relevant documents 640 may be provided to the cache system 212.

When a new cache record is inserted in a cache storage, the cache management module 606 or the corresponding cache module (e.g., the lexical cache module 602, the semantic cache module 604, etc.) may include the document identifier generated for the documents that were used by the AI module 204 to generate the content in the new cache record. Subsequently, if the cache record is accessed based on a match between a reformulated utterance and the key of the cache record, the corresponding cache module may also determine whether the document identifier generated by the ID generation module 616 for the reformulated utterance matches the document identifier that is stored in the cache record. The cache module may determine that the information used by the AI module 204 to generate the content in the cache record is the same as the documents retrieved by the retriever module 614 based on the reformulated utterance (e.g., the information has not been modified since the generation of the content) if the two document identifiers match. The cache module may determine a cache hit, and return the content to the cache management module 606. On the other hand, the cache module may determine that the information used by the AI module 204 to generate the content in the cache record is different from the documents retrieved by the retriever module 614 based on the reformulated utterance (e.g., the information has not updated/modified since the generation of the content) if the two document identifiers do not match. The cache module may then determine a cache miss for the reformulated utterance (even though the reformulated utterance matches the key of the cache record).

Using the invalidation mechanism as disclosed herein, responses that are stored in the cache storages and that were generated by the AI module 204 using outdated information would no longer be retrieved and provided as responses to user utterances, since the cache modules are configured to determine a cache miss when the underlying information used to generate the response in the cache storage is outdated. Due to the TTL associated with the cache records that store these outdated responses, the cache records will be removed from the cache storage(s) at the expiration time specified by the TTL. As discussed herein, even when an utterance matches the key of an outdated cache record, the cache module would not determine a cache hit (in other words, would determine a cache miss) due to the discrepancy between the underlying information. Based on the cache miss(es) from the cache module, the knowledge module 600 may use the AI module 204 to re-generate a response using the up-to-date information retrieved by the retriever module 614 for the utterance. The re-generated response would then be stored in the cache storages in association with the utterance. When the same (or similar) utterance is subsequently received, the cache module may determine a cache hit based on the more updated cache record (and not the outdated cache record), and may return the re-generated response stored in the updated cache record.

Since the responses generated by the AI module 204 and provided to users are in a natural language format, different types of users may have different preferences in the way that the responses are constructed (e.g., some users prefer short and concise responses while others prefer lengthy responses with more details, different users may prefer different tone, different users may prefer different languages or different choice of words, etc.). When the knowledge module 600 and/or the cache management module 606 instructs the AI module 204 to generate a response to an utterance provided by the user, the knowledge module 600 and/or the cache management module 606 may also provide instructions related to the desired characteristics in the response (e.g., lengthy vs. concise, a specific language, choice of words that are specific to a particular geographical region, tone, etc.). In some embodiments, when the response is inserted into the cache storages of the different cache modules 602 and 604, the cache modules 602 and 604 may also store additional data that represents the different characteristics of the corresponding response in the cache records. For example, the additional data may indicate a language (e.g., English, Spanish, German, Chinese, etc.), a specific locale (e.g., United States, England, Scotland, etc.), a specific tone (e.g., professional, casual, etc.), and other characteristics. In some embodiments, the knowledge module 600 may generate a hash value based on all of the characteristics, and store the hash value in the cache record.

When a new utterance is received, the knowledge module 600 may determine additional information associated with the user and/or the user device used to submit the utterance. For example, the knowledge module 600 may determine that the user device is located in a particular geographical region (e.g., a particular country, a particular state, etc.), the utterance is in a particular language, attributes associated with the user (e.g., a user profile associated with the user, etc.). The knowledge module 600 may then determine desired characteristics for a response to the utterance based on the additional information. For example, the knowledge module 600 may determine a language to match the language used in the utterance, determine the choice of words based on the locale associated with the user device, determine the tone and other characteristics based on the user profile, etc. The knowledge module 600 may also generate a hash value based on these characteristics.

The knowledge module 600 may provide the characteristics, along with the utterance and the information retrieved by the retrieval module, to the cache management module 606. When one of the cache modules (e.g., the lexical cache module 602, the semantic cache module 604, etc.) determines that the utterance matches a key in the cache storage, the cache module may also determine whether the underlying information used to generate the corresponding response is identical (or within a threshold similarity) to the information retrieved by the retrieval module, and may determine whether the characteristics of the response match the desired characteristics. The cache module would only determine that a cache hit occurs and returns the response in the cache record associated with the matched key when the underlying information used to generate the corresponding response is identical (or within a threshold similarity) to the information retrieved by the retrieval module, and characteristics of the response match the desired characteristics. As such, even when the utterance matches a key in the cache storage, indicating that a response corresponding to the key can be used as a response to the utterance, the cache module would issue a cache miss and would not return the response if the characteristics of the response do not match the desired characteristics (e.g., the language used in the response is different from the language used in the utterance, the tone used in the response is different from the desired tone, etc.). This way, it can be ensured that the responses being provided to the users through the cache system 212 are personalized for the users.

FIG. 6B illustrates a data flow 660 for querying the lexical cache module 602 according to various embodiments of the disclosure. As the cache management module 606 receives the reformulated utterance 634, the relevant documents 640, and the hash values (e.g., corresponding to the relevant documents 640 and desired characteristics of the response, etc.) from the knowledge module 600, the cache management module 606 may transfer the reformulated utterance 634 and the hash values to a lexical cache driver 622 of the lexical cache module 602. The lexical cache driver 622 may then query the lexical cache storage 624 of the lexical cache module 602 using the reformulated utterance 634 (or keywords extracted from the reformulated utterance 634). If the lexical cache driver 622 determines a cache hit (e.g., when the reformulated utterance 634 matches a key associated with a cache record stored in the lexical cache storage 624, and the hash values also match the values included in the cache record, etc.), the lexical cache driver 622 may obtain the content (e.g., the response 650) stored in the matched cache record from the lexical cache storage 624, and returns the content to the cache management module 606. In addition, the lexical cache driver 622 may also update the cache record based on the cache hit. For example, the lexical cache driver 622 may extend the TTL of the cache record to the predetermined maximum value.

On the other hand, if the lexical cache driver 622 determines a cache miss (e.g., when the reformulated utterance 634 does not match any of the keys in the lexical cache storage 624, or when the reformulated utterance 634 matches a key associated with a cache record stored in the lexical cache storage 624, but the hash values do not match the values included in the cache record, etc.), the lexical cache driver 622 may forward the reformulated utterance 634, the relevant documents 640, and the hash values to a downstream service 626. In this example, the downstream service 626 may include a lower tier cache module (e.g., the semantic cache module 604, etc.) and/or the AI module 204. The lexical cache driver 622 may receive a response from the downstream service 626. The response may include content that was obtained by the lower tier cache module or generated by the AI module 204. The lexical cache driver 622 may forward the response to the cache management module 606, and may update the lexical cache storage 624. For example, the lexical cache driver 622 may create a new cache record based on the response. The lexical cache driver 622 may store the reformulated utterance 634 as the key of the cache record and the response as the value of the cache record. The lexical cache driver 622 may also store the hash values associated with the reformulated utterance 634 in the cache record. The lexical cache driver 622 may assign a TTL (e.g., a predetermined maximum TTL value) to the cache record, and store the cache record in the lexical cache storage 624.

FIG. 6C illustrates a data flow 670 for querying the semantic cache module 604 according to various embodiments of the disclosure. A semantic cache driver 642 of the semantic cache module 604 may receive the reformulated utterance 634, the relevant documents 640, and the hash values from an upstream service 648. In this example, the upstream service 648 may be a higher tier cache module (e.g., the lexical cache module 602). The semantic cache driver 642 may generate (e.g., using the AI module 204, etc.) embeddings based on the reformulated utterance, and may query the semantic cache storage 644 of the semantic cache module 604 using the embeddings. If the semantic cache driver 642 determines a cache hit (e.g., when the embeddings of the reformulated utterance 634 matches a key associated with a cache record stored in the semantic cache storage 644, and the hash values also match the values included in the cache record, etc.), the semantic cache driver 642 may obtain the content (e.g., the response 650) stored in the matched cache record from the semantic cache storage 644, and returns the content to the upstream service 648 (so that the upstream service 648 may update the corresponding cache storages). In addition, the semantic cache driver 642 may also update the cache record based on the cache hit. For example, the semantic cache driver 642 may extend the TTL of the cache record to the predetermined maximum value.

On the other hand, if the semantic cache driver 642 determines a cache miss (e.g., when the reformulated utterance 634 does not match any of the keys in the semantic cache storage 644, or when the reformulated utterance 634 matches a key associated with a cache record stored in the semantic cache storage 644, but the hash values do not match the values included in the cache record, etc.), the semantic cache driver 642 may forward the reformulated utterance 634, the relevant documents 640, and the hash values to a downstream service 626. In this example, the downstream service 646 may include a lower tier cache module (if available) and/or the AI module 204. The semantic cache driver 642 may receive a response from the downstream service 646. The response may include content that was obtained by the lower tier cache module or generated by the AI module 204. The semantic cache driver 642 may forward the response to the upstream service 648, and may update the semantic cache storage 644. For example, the semantic cache driver 642 may create a new cache record based on the response. The semantic cache driver 642 may store the reformulated utterance 634 as the key of the cache record and the response as the value of the cache record. The semantic cache driver 642 may also store the hash values associated with the reformulated utterance 634 in the cache record. The semantic cache driver 642 may assign a TTL (e.g., a predetermined maximum TTL value) to the cache record, and store the cache record in the semantic cache storage 644.

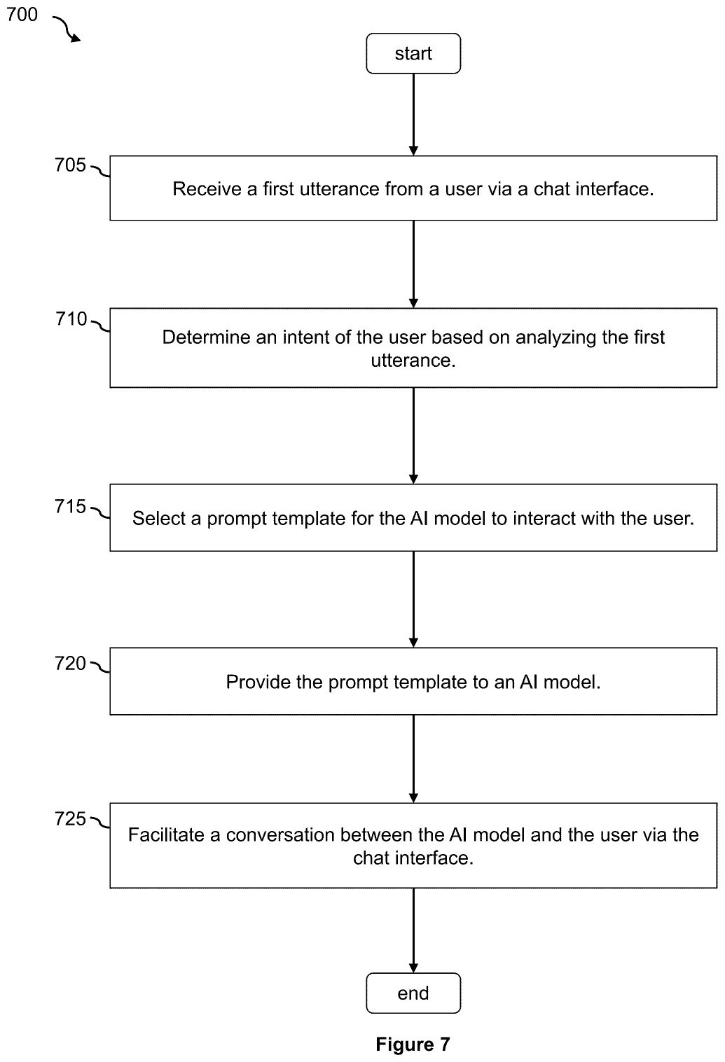

FIG. 7 illustrates a process 700 for facilitating a conversation during a chat session according to various embodiments of the disclosure. In some embodiments, at least a portion of the process 700 may be performed by the conversation module 132, although one or more steps may be performed by one or more of the components/devices/modules/systems described herein. The process 700 begins by receiving (at step 705) a first utterance from a user via a chat interface and determining or predicting (at step 710) an intent of the user based on analyzing the first utterance. For example, the user 140 may use the chat client 170 to request to have, or initiate, a chat session with the conversation module 132. The conversation module 132 may establish a chat session with the chat client 170 of the user device 110 using the techniques disclosed herein. The user 140 may use the chat client 170 to exchange data with the conversation module 132 during the chat session. For example, the user 140 may transmit an utterance (e.g., one or more phrases, one or more sentences, etc. in text, voice, or other means) to the conversation module 132 via the chat client 170. Upon receiving the utterance, the conversation management module 202 may process the utterance using one or more tools in the tool repository 206 according to the tool execution information. In some embodiments, the conversation management module 202 may use the intent determination tool 308 to determine an intent of the user 140 based on the utterance. The intent determined for the user 140 may indicate a type of transaction that the user wishes to perform.

The process 700 then selects (at step 715) a prompt template for the AI model to interact with the user and provide (at step 720) the prompt template to the AI model. For example, after determining the intent of the user 140 (e.g., a type of transaction that the user wishes to perform), the conversation management module 132 may determine that a backend module (e.g., one of the backend modules 242, 244, 246, 248, and 250) is capable of processing the transaction for the user. The conversation management module 132 may then retrieve a specification (also referred to as a “prompt template”) from the prompt repository 208 that corresponds to the selected backend module, and provide the specification to the AI module 204.

The process 700 facilitates (at step 725) a conversation between the AI model and the user via the chat interface. For example, based on the specification provided by the conversation management module 202, the AI module 204 may determine the types or content of data that is required by the selected backend module to process the transaction for the user. The AI module 204 may begin conducting a conversation with the user 140 via the chat interface 210.

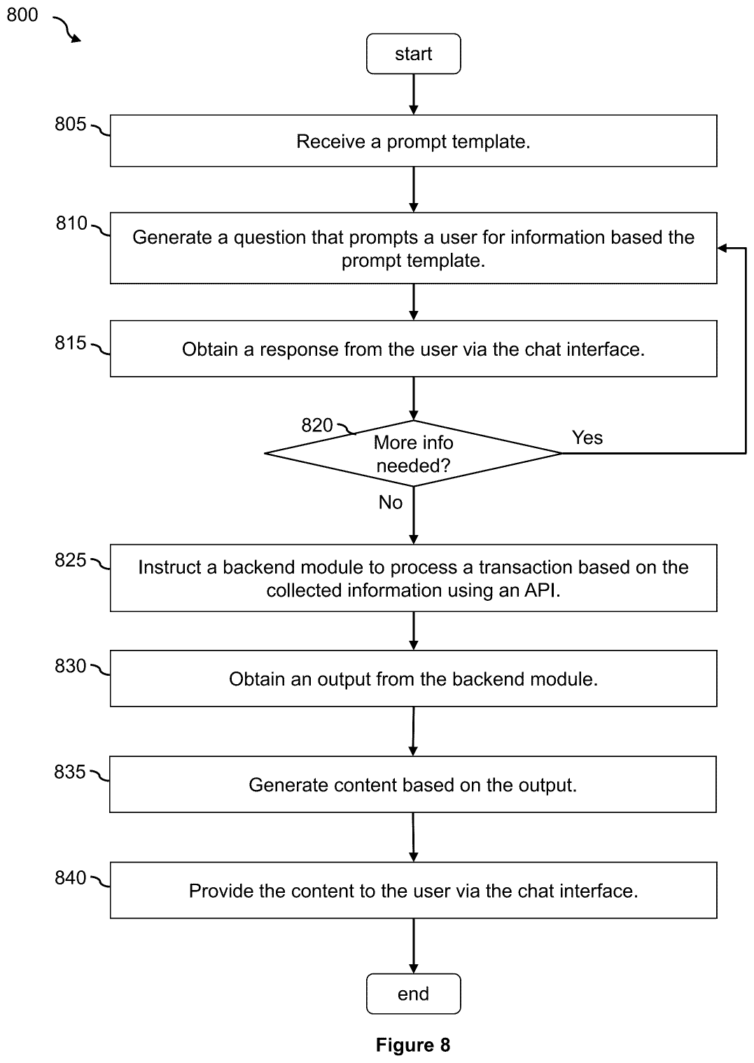

FIG. 8 illustrates a process 800 for processing a transaction for a user during a chat session according to various embodiments of the disclosure. In some embodiments, at least a portion of the process 800 may be performed by the AI module 204, although one or more steps may be performed by one or more of the components/devices/modules/systems described herein. The process 800 begins by receiving a prompt template (at step 805). For example, as discussed above by reference to FIG. 7, the AI module 204 may receive a specification from the conversation management module 202. The specification may indicate the backend module that is capable of processing a transaction that is requested by the user 140. The specification may also include information related to the interfaces (e.g., formats of the API calls, etc.) that can be used to communicate (e.g., providing instructions) with the backend module, and the types of data (e.g., input parameters) required by the backend module to process the transaction.

The process 800 generates (at step 810) a question or inquiry that prompts a user for information based on the prompt template and obtains (at step 815) a response from the user via the chat interface. The process 800 then determines (at step 820) if more information is needed. If more information is needed, the process 800 reverts back to the step 810 to generate another question that prompts the user for the missing information. For example, once the AI module 204 determines the types or content of data required by the backend module to process the transaction, the AI module 204 may generate one or more questions that prompt the user for the types or content of data required by the backend module. In some embodiments, the AI module 204 may perform one or more dialogue turns (e.g., asking multiple questions, etc.) before the AI module 204 is able to obtain all of the required data for the backend module. In some embodiments, each time the AI module 204 obtains new information from the user via the chat interface 210, the AI module 204 may insert the information into a corresponding position in the specification. The AI module 204 may determine whether there is still missing information based on the specification, and may continue to generate questions to prompt the user for the missing information until all of the required information has been obtained.

On the other hand, if no more information is needed, the process 800 instructs (at step 825) a backend module to process a transaction based on the collected information using an API. For example, the AI module 204 may generate instructions (e.g., one or more API calls) for the backend module based on the information included in the specification. The AI module 204 may also use the information obtained from the user to generate input parameters for the API calls. The AI module 204 may then transmit the instructions to the corresponding backend module.

The process 800 then obtains (at step 830) an output from the backend module, generates (at step 835) content based on the output, and provides (at step 840) the content to the user via the chat interface. For example, the backend module may be configured to process a transaction for the user based on the instructions provided by the AI module 204. After processing the transaction, the backend module may generate an output (e.g., information retrieved from various sources associated with the service provider server, a signal indicating whether the transaction has been processed successfully, etc.), and transmits the output to the AI module 204 (e.g., as a return value for the instructions). Based on the output, the AI module 204 may generate content for the user. For example, when the output includes information retrieved from various sources, the AI module 204 may generate a summary of the information. In another example, when the output indicates whether the transaction was performed successfully, the AI module 204 may generate an utterance that informs the user of the result of processing the transaction. The AI module 204 may then transmit the content to the user device 110 via the chat interface 210.

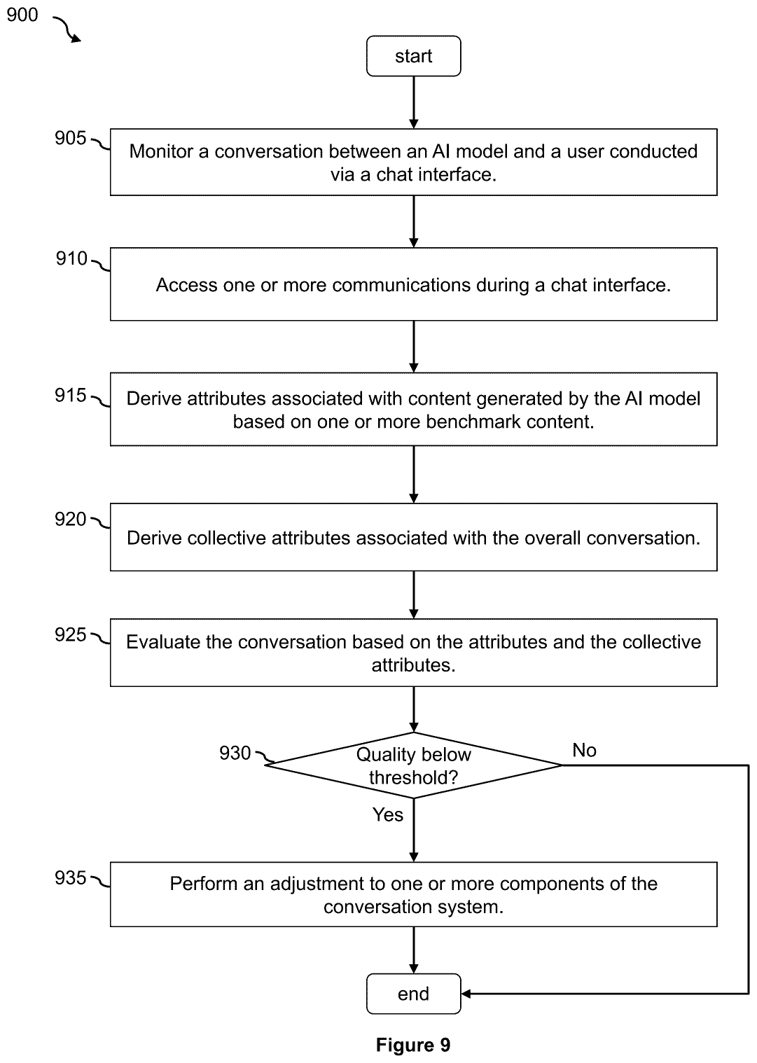

FIG. 9 illustrates a process 900 for evaluating the performance of the conversation module 132 according to various embodiments of the disclosure. In some embodiments, at least a portion of the process 900 may be performed by the evaluation module 222, although one or more steps may be performed by one or more of the components/devices/modules/systems described herein. The process 900 begins by monitoring (at step 905) a conversation between an AI model and a user conducted via a chat interface and accessing (at step 910) one or more communications during a chat interface. For example, the monitoring module 502 may monitor communications between the device 510 and the conversation module 132, and data transmitted among different components of the conversation module 132 (e.g., the conversation management module 202, the AI module 204, and the backend modules 540, etc.) during a chat session with a user.

The process 900 then derives (at step 915) attributes associated with content generated by the AI model based on one or more benchmark content, and derives (at step 920) collective attributes associated with the overall conversation. For example, the evaluation module 222 may compare contents generated by the AI module 204 against benchmark contents stored in the benchmark database 530. In some embodiments, the evaluation module 222 may evaluate both the semantic quality and the syntactic quality of the contents based on the comparisons. The evaluation module 222 may also derive attributes associated with the overall conversation between the conversation module 132 and the user of the device 510. The attributes may include the number of dialogue turns conducted between the conversation module 132 and the user of the device 510 before a transaction is completed for the user.

At step 925, the process 900 evaluates the conversation based on the attributes and the collective attributes. If it is determined that the quality of the conversation is below a threshold at step 930, the process 900 performs an adjustment to one or more components of the conversation system. For example, based on the overall quality of the conversation, and the semantic and syntactic qualities of individual contents generated by the AI module 204, the evaluation module 222 may determine if the quality of the conversation is below a threshold. If the quality of the conversation is below the threshold, the evaluation module 222 may use the modification module 504 to adjust one or more components within the conversation module 132, such as adjusting one or more parameters of the AI module 204, modifying one or more tools in the tool repository 206, modifying one or more specification, and/or modifying one or more backend modules.

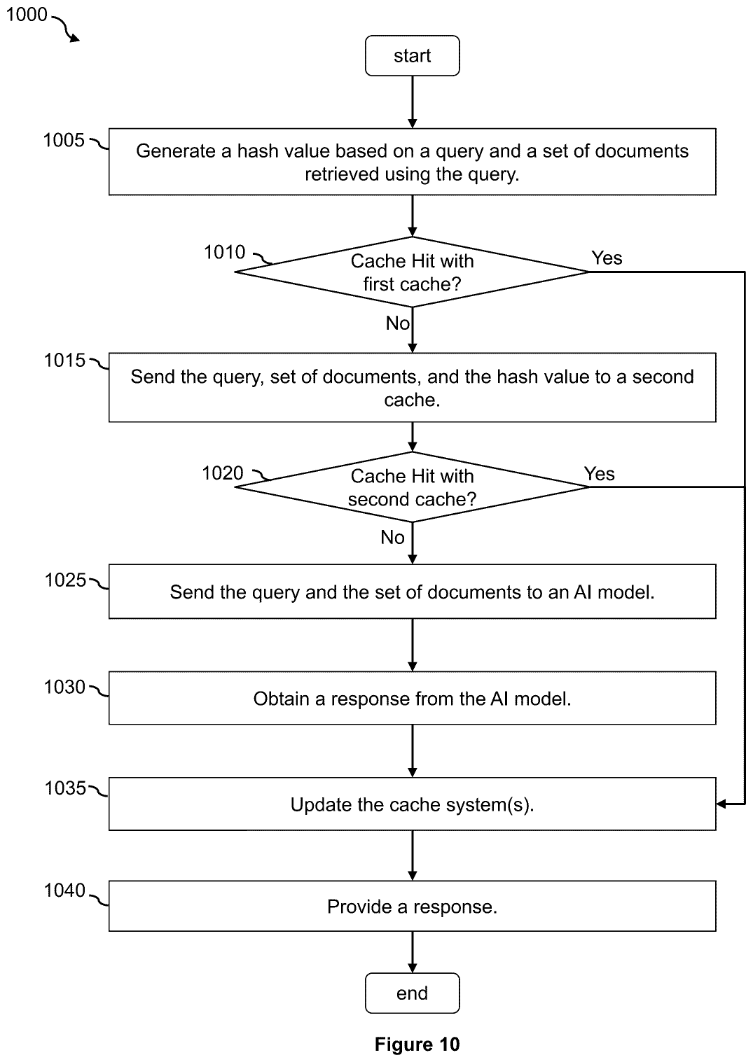

FIG. 10 illustrates a process 1000 for using a cache system to enhance the speed performance of the AI-based conversation system according to various embodiments of the disclosure. In some embodiments, at least a portion of the process 1000 may be performed by the knowledge module 600 and the cache system 212, although one or more steps may be performed by one or more of the components/devices/modules/systems described herein. The process 1000 begins by generating (at step 1005) a hash value based on a query and a set of documents retrieved using the query. For example, as the knowledge module 600 receives the utterance 632 from a user device via the conversation management module 202, the knowledge module 600 may use the query reformulator module 612 to reformulate the utterance 632, and use the retriever module 614 to retrieve a set of documents 640 relevant to the utterance 632 based on the reformulated query 634. In addition, the knowledge module 600 my also use the ID generation module 616 to generate one or more hash values that represent the set of documents 640 and/or one or more desired characteristics associated with a response to the utterance 632. The knowledge module 600 may provide the reformulated utterance 634, the set of documents 640, and the hash value to the cache system 212.

The cache system 212 may include multiple tiers of cache modules, where each cache module may use a different structure for querying/caching data. For example, the cache system 212 may include the lexical cache module 602 in a first tier and the semantic cache module 604 in a second tier of the cache system 212. The cache system 212 first provides the reformulated utterance 634 and the hash value to the lexical cache module 602. The lexical cache module 602 then determines (at step 1010) whether a cache hit occurs based on the reformulated utterance 632. A cache hit occurs when the lexical cache module 602 determines that the reformulated utterance 634 matches a key associated with one of the cache records stored in the cache storage of the lexical cache module 602. If a cache hit has occurred, the lexical cache module 602 updates (at step 1035) the cache system, for example, by extending the TTL of the cache record associated with the cache hit, and provides (at step 1040) the value from the cache record as a response to the knowledge module 600.

On the other hand, if a cache hit does not occur (e.g., the lexical cache module 602 determines a cache miss as the reformulated utterance 634 does not match any key in the cache records, etc.), the lexical cache module 602 sends (at step 1015) the reformulated utterance 634, the set of documents 640, and the hash value to the second tier in the cache system 212 (e.g., the semantic cache module 604).

Similar to the lexical cache module 602, the semantic cache module 604 also determines (at step 1020) whether a cache hit occurs based on the reformulated utterance 634. In some embodiments, the semantic cache module 604 generates embeddings (e.g., vectors) based on the reformulated utterance 634, and determine whether the embeddings match any key in the cache records stored in the cache storage of the semantic cache module 604. A cache hit occurs when the semantic cache module 604 determines that the embeddings of the reformulated utterance 634 matches a key associated with one of the cache records stored in the cache storage of the semantic cache module 604. If a cache hit has occurred, the semantic cache module 604 updates (at step 1035) the cache system, for example, by extending the TTL of the cache record associated with the cache hit, and provides (at step 1040) the value from the cache record as a response to the knowledge module 600.

On the other hand, if a cache hit does not occur (e.g., the semantic cache module 604 determines a cache miss as the embeddings of the reformulated utterance 634 do not match any key in the cache records, etc.), the cache management module 606 sends (at step 1025) the reformulated utterance 634 and the set of documents 640 to the AI module 204. For example, the cache management module 606 and/or the knowledge module 600 may generate a prompt that includes the reformulated utterance 634, the set of documents 640, and the desired characteristics for a response. Based on the prompt, the AI module 204 is configured to generate a response 650 for the utterance 632. The cache management module 606 obtains (at step 1030) the response 650 from the AI module 204, and provides the response 650 to the knowledge module 600.

The cache management module 606 also updates (at step 1035) the cache system 212 based on the response 650 generated by the AI module 204. For example, the cache system 212 may generate new cache records based on the reformulated utterance 634 and the response 650, and may store the new cache records in the cache storages of the lexical cache module 602 and the semantic cache module 604, respectively.

Upon receiving the response 650 from the cache management module 606, the knowledge module 600 may reformulate the response 650 (e.g., incorporating personalized information into the response 650), and provide (at step 1040) the reformulated response 652 to the user device via the conversation management module 202.

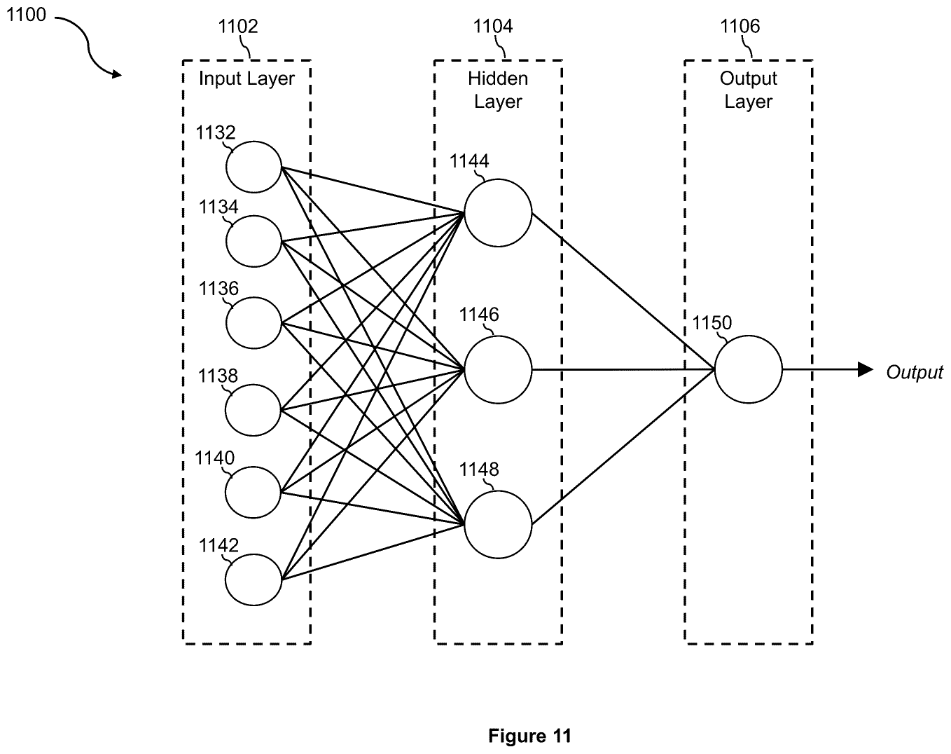

FIG. 11 illustrates an example artificial neural network 1100 that may be used to implement a machine learning model, such as the AI model associated with the AI module 204, the machine learning model associated with the caching module 212, and the machine learning model associated with the evaluation module 222. As shown, the artificial neural network 1100 includes three layers—an input layer 1102, a hidden layer 1104, and an output layer 1106. Each of the layers 1102, 1104, and 1106 may include one or more nodes (also referred to as “neurons”). For example, the input layer 1102 includes nodes 1132, 1134, 1136, 1138, 1140, and 1142, the hidden layer 1104 includes nodes 1144, 1146, and 1148, and the output layer 1106 includes a node 1150. In this example, each node in a layer is connected to every node in an adjacent layer via edges and an adjustable weight is often associated with each edge. For example, the node 1132 in the input layer 1102 is connected to all of the nodes 1144, 1146, and 1148 in the hidden layer 1104. Similarly, the node 1144 in the hidden layer is connected to all of the nodes 1132, 1134, 1136, 1138, 1140, and 1142 in the input layer 1102 and the node 1150 in the output layer 1006. While each node in each layer in this example is fully connected to the nodes in the adjacent layer(s) for illustrative purpose only, it has been contemplated that the nodes in different layers can be connected according to any other neural network topologies as needed for the purpose of performing a corresponding task.

The hidden layer 1104 is an intermediate layer between the input layer 1102 and the output layer 1106 of the artificial neural network 1100. Although only one hidden layer is shown for the artificial neural network 1100 for illustrative purpose only, it has been contemplated that the artificial neural network 1100 used to implement any one of the computer-based models may include as many hidden layers as necessary. The hidden layer 1104 is configured to extract and transform the input data received from the input layer 1102 through a series of weighted computations and activation functions.

In this example, the artificial neural network 1100 receives a set of inputs and produces an output. Each node in the input layer 1102 may correspond to a distinct input. For example, when the artificial neural network 1100 is used to implement the AI model associated with the AI module 204, the nodes in the input layer 1102 may correspond to different parameters and/or attributes of a prompt (which may be generated based on the modified utterance 432 and a specification 402, the reformulated utterance 634 and the set of documents 650, etc.).

In some embodiments, each of the nodes 1144, 1146, and 1148 in the hidden layer 1104 generates a representation, which may include a mathematical computation (or algorithm) that produces a value based on the input values received from the nodes 1132, 1134, 1136, 1138, 1140, and 1142. The mathematical computation may include assigning different weights (e.g., node weights, edge weights, etc.) to each of the data values received from the nodes 1132, 1134, 1136, 1138, 1140, and 1142, performing a weighted sum of the inputs according to the weights assigned to each connection (e.g., each edge), and then applying an activation function associated with the respective node (or neuron) to the result. The nodes 1144, 1146, and 1148 may include different algorithms (e.g., different activation functions) and/or different weights assigned to the data variables from the nodes 1132, 1134, 1136, 1138, 1140, and 1142 such that each of the nodes 1144, 1146, and 1148 may produce a different value based on the same input values received from the nodes 1132, 1134, 1136, 1138, 1140, and 1142. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 1102 is transformed into rather different values indicative data characteristics corresponding to a task that the artificial neural network 1100 has been designed to perform.

In some embodiments, the weights that are initially assigned to the input values for each of the nodes 1144, 1146, and 1148 may be randomly generated (e.g., using a computer randomizer). The values generated by the nodes 1144, 1146, and 1148 may be used by the node 1150 in the output layer 1106 to produce an output value (e.g., a response to a user query, a prediction, etc.) for the artificial neural network 1100. The number of nodes in the output layer depends on the nature of the task being addressed. For example, in a binary classification problem, the output layer may consist of a single node representing the probability of belonging to one class (as in the example shown in FIG. 11). In a multi-class classification problem, the output layer may have multiple nodes, each representing the probability of belonging to a specific class. When the artificial neural network 1100 is used to implement the AI model associated with the AI module 204, the output node 1150 may be configured to generate new content (e.g., a response in a natural language format, instructions for the backend modules, etc.) based on the prompt.

In some embodiments, the artificial neural network 1100 may be implemented on one or more hardware processors, such as CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware used to implement the neural network structure is specifically configured based on factors such as the complexity of the neural network, the scale of the tasks (e.g., training time, input data scale, size of training dataset, etc.), and the desired performance.

The artificial neural network 1100 may be trained by using training data based on one or more loss functions and one or more hyperparameters. By using the training data to iteratively train the artificial neural network 1100 through a feedback mechanism (e.g., comparing an output from the artificial neural network 1100 against an expected output, which is also known as the “ground-truth” or “label”), the parameters (e.g., the weights, bias parameters, coefficients in the activation functions, etc.) of the artificial neural network 1100 may be adjusted to achieve an objective according to the one or more loss functions and based on the one or more hyperparameters such that an optimal output is produced in the output layer 1106 to minimize the loss in the loss functions. Given the loss, the negative gradient of the loss function is computed with respect to each weight of each layer individually. Such negative gradient is computed one layer at a time, iteratively backward from the last layer (e.g., the output layer 1106 to the input layer 1102 of the artificial neural network 1100). These gradients quantify the sensitivity of the network's output to changes in the parameters. The chain rule of calculus is applied to efficiently calculate these gradients by propagating the gradients backward from the output layer 1106 to the input layer 1102.

Parameters of the artificial neural network 1100 are updated backwardly from the last layer to the input layer (backpropagating) based on the computed negative gradient using an optimization algorithm to minimize the loss. The backpropagation from the last layer (e.g., the output layer 1106) to the input layer 1102 may be conducted for a number of training samples in a number of iterative training epochs. In this way, parameters of the artificial neural network 1100 may be gradually updated in a direction to result in a lesser or minimized loss, indicating the artificial neural network 1100 has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as to predict a frequency of future related transactions.

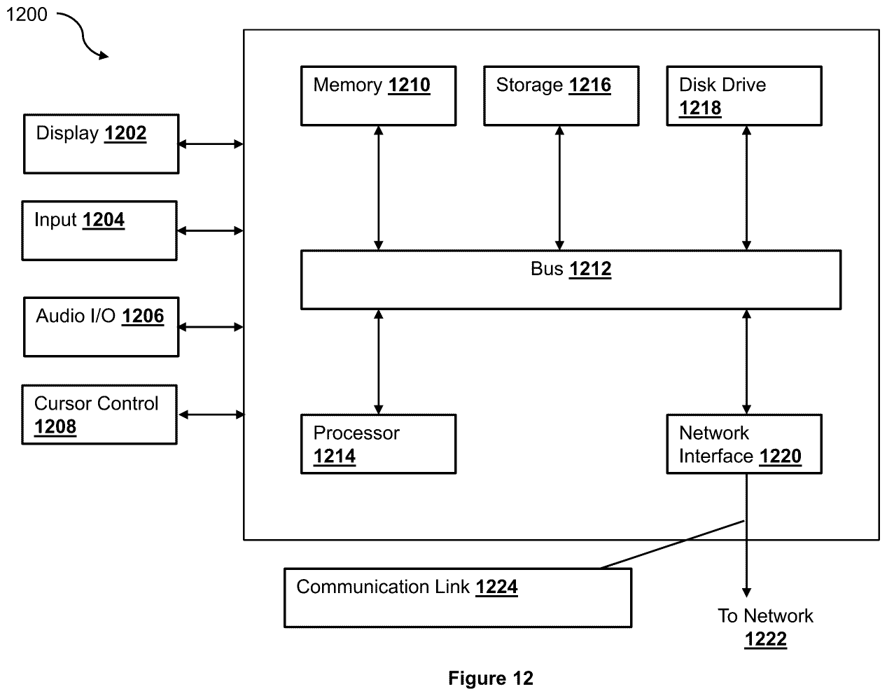

FIG. 12 is a block diagram of a computer system 1200 suitable for implementing one or more embodiments of the present disclosure, including the service provider server 130, the merchant server 120, the user device 180, and the user device 110. In various implementations, each of the user devices 110 and 180 may include a mobile cellular phone, personal computer (PC), laptop, wearable computing device, etc. adapted for wireless communication, and each of the service provider server 130 and the merchant server 120 may include a network computing device, such as a server. Thus, it should be appreciated that the devices 110, 120, 130, and 180 may be implemented as the computer system 1200 in a manner as follows.

The computer system 1200 includes a bus 1212 or other communication mechanism for communicating information data, signals, and information between various components of the computer system 1200. The components include an input/output (I/O) component 1204 that processes a user (i.e., sender, recipient, service provider) action, such as selecting keys from a keypad/keyboard, selecting one or more buttons or links, etc., and sends a corresponding signal to the bus 1212. The I/O component 1204 may also include an output component, such as a display 1202 and a cursor control 1208 (such as a keyboard, keypad, mouse, etc.). The display 1202 may be configured to present a login page for logging into a user account or a checkout page for purchasing an item from a merchant. An optional audio input/output component 1206 may also be included to allow a user to use voice for inputting information by converting audio signals. The audio I/O component 1206 may allow the user to hear audio. A transceiver or network interface 1220 transmits and receives signals between the computer system 1200 and other devices, such as another user device, a merchant server, or a service provider server via a network 1222. In one embodiment, the transmission is wireless, although other transmission mediums and methods may also be suitable. A processor 1214, which can be a micro-controller, digital signal processor (DSP), or other processing component, processes these various signals, such as for display on the computer system 1200 or transmission to other devices via a communication link 1224. The processor 1214 may also control transmission of information, such as cookies or IP addresses, to other devices.

The components of the computer system 1200 also include a system memory component 1210 (e.g., RAM), a static storage component 1216 (e.g., ROM), and/or a disk drive 1218 (e.g., a solid-state drive, a hard drive). The computer system 1200 performs specific operations by the processor 1214 and other components by executing one or more sequences of instructions contained in the system memory component 1210. For example, the processor 1214 can perform the automated conversation functionalities described herein, for example, according to the processes 700, 800, 900, and 1000.

Logic may be encoded in a computer readable medium, which may refer to any medium that participates in providing instructions to the processor 1214 for execution. Such a medium may take many forms, including but not limited to, non-volatile media, volatile media, and transmission media. In various implementations, non-volatile media includes optical or magnetic disks, volatile media includes dynamic memory, such as the system memory component 1210, and transmission media includes coaxial cables, copper wire, and fiber optics, including wires that comprise the bus 1212. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 1200. In various other embodiments of the present disclosure, a plurality of computer systems 1200 coupled by the communication link 1224 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled with the non-transitory memory and configured to execute instructions from the non-transitory memory to cause the system to:
receive a query from a user device;
provide the query to a multi-tiered cache system associated with an artificial intelligence (AI) model, wherein the multi-tiered cache system comprises a plurality of cache modules that stores pre-generated responses from the AI model;
determine that the query does not result in a first cache hit associated with a first cache module of the plurality of cache modules;
generate embeddings based on the query;
determine whether the query results in a second cache hit associated with a second cache module of the plurality of cache modules based on the embeddings;
obtain a response from one of the second cache module or the AI model; and
update the first cache module based on the response.

2. The system of claim 1, wherein executing the instructions further causes the system to:
transmit the response to the user device.

3. The system of claim 1, wherein executing the instructions further causes the system to:
retrieve a set of documents from a data storage based on the query; and
generate a hash value based on the set of documents, wherein determining that the query does not result in the first cache hit associated with the first cache module is further based on the hash value.

4. The system of claim 3, wherein determining whether the query results in the second cache hit associated with the second cache module is further based on the hash value.

5. The system of claim 1, wherein the second cache module comprises a plurality of records, wherein each record of the plurality of records is associated with an expiration time.

6. The system of claim 5, wherein the response is obtained from the second cache module based on the query resulting in the second cache hit associated with the second cache module, and wherein executing the instructions further causes the system to:
update a first expiration time associated with a first record in the second cache module that stores the response based on the second cache hit.

7. The system of claim 5, wherein executing the instructions further causes the system to:
determine that a second record in the second cache module has expired based on a second expiration time associated with the second record; and
remove the second record from the second cache module.

8. A method comprising:
in response to receiving an utterance from a user device, providing, by a computer system, the utterance to a multi-tiered cache system associated with an artificial intelligence (AI) model, wherein the multi-tiered cache system comprises a plurality of cache modules;
determining, by the computer system, a first cache miss for a first cache module in the plurality of cache modules based on the utterance;
generating, by the computer system, embeddings based on the utterance;
in response to determining the cache miss for the first cache module, providing, by the computer system, the utterance to a second cache module in the plurality of cache modules;
obtaining, by the computer system, a response from one of the second cache module or the AI model; and
updating, by the computer system, the first cache module based on the response.

9. The method of claim 8, further comprising:
determining a second cache miss for the second cache module based on the embeddings;
in response to determining the second cache miss, generating a prompt for the AI model, the prompt including the utterance; and
providing the prompt to the AI model, wherein the AI model is configured to generate the response based on the prompt.

10. The method of claim 8, further comprising:
determining that the utterance comprises data of a particular type; and
modifying the utterance based on removing the data from the utterance, wherein the response is generated based on the modified utterance.

11. The method of claim 10, further comprising:
modifying the response based on incorporating the data into the response; and
providing the modified response to the user device.

12. The method of claim 8, wherein the updating the first cache module comprises:
storing the response in the first cache module.

13. The method of claim 8, wherein the response is obtained from the second cache module based on a cache hit with the second cache module, wherein the method further comprises:
updating a first expiration time associated with a first record in the second cache module that stores the response based on the cache hit.

14. The method of claim 8, further comprising:
determining that a second record in the second cache module has expired based on a second expiration time associated with the second record; and
removing the second record from the second cache module.

15. A non-transitory machine-readable medium having stored thereon machine-readable instructions executable to cause a machine to perform operations comprising:
receiving an utterance from a user device;
providing the utterance to a first cache module of a cache system associated with an artificial intelligence (AI) model;
determining that a first cache hit does not occur at the first cache module based on the utterance;
subsequent to the determining that the first cache hit does not occur at the first cache module, providing the utterance to a second cache module of the cache system;
determining whether a second cache hit occurs at a second cache module based on the utterance;
obtaining a response from one of the second cache module or the AI model; and
providing the response to the user device.

16. The non-transitory machine-readable medium of claim 15, wherein the operations further comprise:
updating the first cache module based on the response.

17. The non-transitory machine-readable medium of claim 16, wherein the updating the first cache module comprises:
storing the response in the first cache module.

18. The non-transitory machine-readable medium of claim 15, wherein the operations further comprise:
retrieving a set of documents from a data storage based on the utterance; and
generating a hash value based on the set of documents, wherein the determining that the first cache hit does not occur at the first cache module is further based on the hash value.

19. The non-transitory machine-readable medium of claim 19, wherein the determining whether the second cache hit occurs at the second cache module is further based on the hash value.

20. The non-transitory machine-readable medium of claim 15, wherein the operations further comprise:
selecting, from a plurality of computer modules, a particular computer module for performing a transaction based on the utterance;
generating, by the AI model, instructions that cause the particular computer module to perform the transaction for a user of the user device;
generating, by the AI model, based on a result from the particular computer module performing the transaction; and
transmitting the content to the user device.
